(19) United States
(12) Patent Application Publication
(10) Pub. No.: US 2024/0072312 A1
(43) Pub. Date: Feb. 29, 2024

(54) Battery Management System Control Circuitry

(71) Applicant: Form Energy, Inc., Somerville, MA (US)

(72) Inventors: Tuan Minh Truong, Newark, CA (US); Tyler Grandahl, Carlisle, MA (US); Keith William Johnston, Alameda, CA (US); Jhalak Joshipura Vasavada, San Ramon, CA (US); Grant Harrison Friesen, Concord, CA (US)

(21) Appl. No.: 18/454,017

(22) Filed: Aug. 22, 2023

Related U.S. Application Data
(60) Provisional application No. 63/400,315, filed on Aug. 23, 2022.

(51) Int. Cl. H01M 10/42; H01M 10/48; H01M 12/08; H02J 7/00

(52) U.S. Cl. CPC H01M 10/425; H01M 10/484; H01M 12/08; H02J 7/0047; H01M 2010/4271

(57) ABSTRACT

Systems, methods, and devices of the various embodiments may provide control and/or sensing circuit configurations for electrochemical energy storage systems, such as metal-air battery systems. Various embodiments may include systems, methods, and devices supporting terminal switching between a charge cathode and a discharge cathode of a metal-air battery, bypass switching for the metal-air battery, and/or electrolyte low level detection for the metal-air battery.

### RELATED APPLICATIONS

This application claims the benefit of priority to U.S. Provisional Application No. 63/400,315 entitled “Battery Management System Control Circuitry” filed Aug. 23, 2022, the entire contents of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems, methods, and devices of the various embodiments may include configurations for power systems. Systems and methods of the various embodiments may provide configurations for components of battery systems. Various embodiments may provide control and/or sensing circuit configurations for electrochemical energy storage systems, such as metal-air battery systems. Various embodiments may include electrolyte fluid level sensors. Various embodiments may include cathode switching for multi-cathode battery cells. Various embodiments may include systems, methods, and devices supporting terminal switching between a charge cathode and a discharge cathode of a metal-air battery, bypass switching for the metal-air battery, and/or electrolyte low level detection for the metal-air battery.

Various embodiments may include a battery system comprising: a plurality of metal-air batteries electrically connected together, wherein each metal-air battery comprises: a charge cathode; a discharge cathode; a metal anode; and a liquid electrolyte; and cell electronics associated with each of the plurality of metal-air batteries, wherein each cell electronics provides, one or more of the following: terminal switching between the charge cathode and the discharge cathode of the respective metal-air battery; bypass switching for the metal-air battery; and/or electrolyte low level detection for the metal-air battery.

### DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a system block diagram of a power generation system according to various embodiments.

FIG. 2 is a system block diagram of a power generation system according to various embodiments.

FIG. 3 is a component diagram of an electrochemical cell, according to various embodiments of the present disclosure.

FIG. 4A is a schematic diagram of an example single electrochemical cell enclosure configuration in accordance with various embodiments.

FIG. 4B is an exploded diagram of internal portions of an example cell enclosure configuration in accordance with various embodiments.

FIGS. 5A-5D are schematic diagrams of example module configurations including multiple electrochemical cells in accordance with various embodiments.

FIGS. 6A-6C illustrate portions of a battery module enclosure in accordance with various embodiments.

FIGS. 7A-7C illustrate battery module enclosure configurations in accordance with various embodiments.

FIGS. 8A-8E illustrate an example module layout within an enclosure in accordance with various embodiments.

FIGS. 9A-9F illustrate an example module layout within an enclosure in accordance with various embodiments.

FIGS. 10A-10E illustrate an example module layout within an enclosure in accordance with various embodiments.

FIGS. 11A, 11B, and 11C are circuit diagrams of example cell discharging, cell charging, and cell bypass operations in accordance with various embodiments.

FIG. 12 is a circuit diagram of an example cell switching topology in accordance with various embodiments.

FIG. 13 is a circuit diagram of an example semiconductor based cell switching topology in accordance with various embodiments.

FIG. 14 is a block diagram illustrating an example of an interlocking loop electrolyte low electrolyte fluid level detection circuit in accordance with various embodiments.

FIG. 15 illustrates cell electrolyte fluid level sensor configurations utilizing isolated electrolyte fluid level probes in accordance with various embodiments.

FIG. 16 illustrates an isolated electrolyte fluid sensor design in accordance with various embodiments.

FIG. 17 illustrates an isolated electrolyte fluid sensor design in accordance with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention.

The following examples are provided to illustrate various embodiments of the present systems and methods of the present inventions. These examples are for illustrative purposes, may be prophetic, should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A, A″, C, and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure.

Embodiments of the present invention may include systems, methods, and devices for electrochemical energy storage systems, such as metal-air battery systems. Various embodiments may provide control and/or sensing circuit configurations for electrochemical energy storage systems, such as metal-air battery systems. Various embodiments may include electrolyte fluid level sensors. Various embodiments may include electrode switching, such as cathode switching, for multi-electrode battery cells, such as for multi-cathode battery cells.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation, and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, a long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as zinc-air, lithium-air, sodium-air, etc.

As used herein, the term “module” may refer to a string of unit cells (e.g., a string of batteries). Multiple modules (or multiple units or cells) may be connected together to form battery strings.

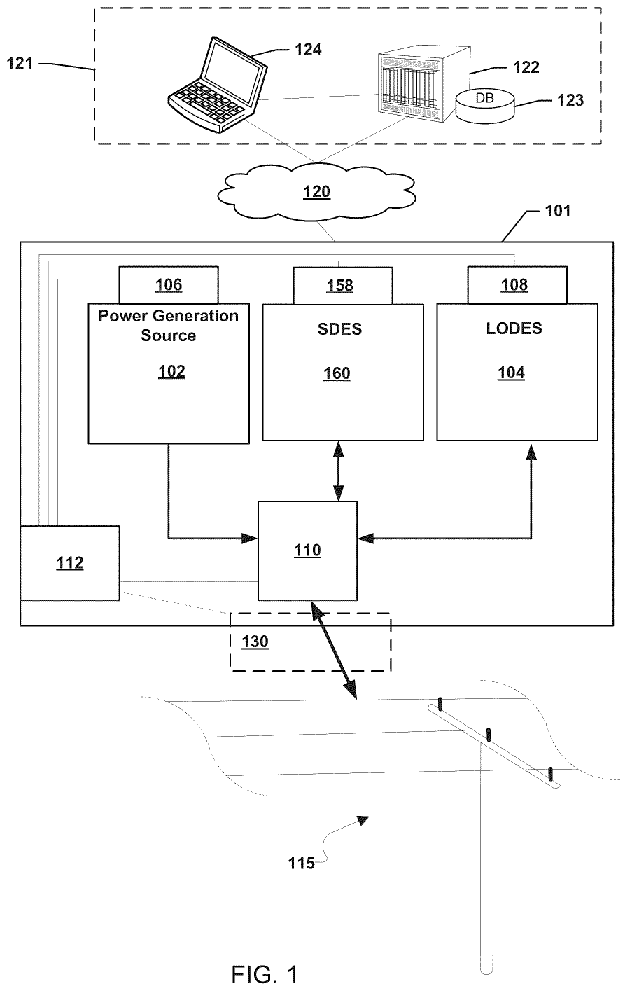

FIG. 1 is a system block diagram of a power generation system (also referred to as a power system) 101 according to various embodiments. The power generation system 101 may be a power plant including one or more power generation sources 102, one or more LODES systems 104 (e.g., a multi-day energy storage (MDS) system), and one or more SDES systems 160. As examples, the power generation sources 102 may be renewable power generation sources, non-renewable power generation sources, combinations of renewable and non-renewable power generation sources, etc. Examples of power generation sources 102 may include wind generators, solar generators, geothermal generators, nuclear generators, etc. The LODES system 104 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Al, AlCl₃, Fe, FeOₓ(OH)_{y}, NaₓS_{y}, SiOₓ(OH)_{y}, AlOₓ(OH)_{y}, metal-air, and/or any suitable type of battery chemistry. The SDES system 160 may include one or more electrochemical cells (e.g., one or more batteries). The batteries may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation sources 102 may be controlled by one or more control systems 106. The control systems 106 may include motors, pumps, fans, switches, relays, or any other type devices that may serve to control the generation of electricity by the power generation sources 102. In various embodiments, the operation of the LODES system 104 may be controlled by one or more control systems 108. The control systems 108 may include motors, pumps, fans, switches, relays, or any other type devices that may serve to control the discharge and/or storage of electricity by the LODES system. In various embodiments, the operation of the SDES system 160 may be controlled by one or more control systems 158. The control systems 158 may include motors, pumps, fans, switches, relays, or any other type devices that may serve to control the discharge and/or storage of electricity by the SDES system. The control systems 106, 108, 158 may all be connected to a plant controller 112. The plant controller 112 may monitor the overall operation of the power generation system 101 and generate and send control signals to the control systems 106, 108, 158 to control the operations of the power generation sources 102, LODES system 104, and/or SDES system 104.

In the power generation system 101, the power generation sources 102, the LODES system 104, and the SDES system 160 may all be connected to one or more power control devices 110. The power control devices 110 may be connected to a power grid 115 or other transmission infrastructure. The power control devices 110 may include switches, inverters (e.g., AC to DC inverters, DC to AC inverters, etc.), relays, power electronics, and any other type devices that may serve to control the flow of electricity from to/from one or more of the power generation sources 102, the LODES system 104, the SDES system 160, and/or the power grid 115. Additionally, the power generation system 101 may include transmission facilities 130 connecting the power generation, transmission, and storage system 101 to the power grid 115. As an example, the transmission facilities 130 may connect between the power control devices 110 and the power grid 115 to enable electricity to flow between the power generation system 101 and the power grid 115. Transmission facilities 130 may include transmission lines, distribution lines, power cables, switches, relays, transformers, and any other type devices that may serve to support the flow of electricity between the power generation system 101 and the power grid 115. The power control devices 110 and/or transmission facilities 130 may be connected to the plant controller 112. The plant controller 112 may monitor and control the operations of the power control devices 110 and/or transmission facilities 130, such as via various control signals. As examples, the plant controller 112 may control the power control devices 110 and/or transmission facilities 130 to provide electricity from the power generation sources 102 to the power grid 115, to provide electricity from the LODES system 104 to the power grid 115, to provide electricity from both the power generation sources 102 and the LODES system 104 to the power grid 115, to provide electricity from the power generation sources 102 to the LODES system 104, to provide electricity from the grid 115 to the LODES system 104, to provide electricity from the SDES system 160 to the power grid 115, to provide electricity from both the power generation sources 102 and the SDES system 160 to the power grid 115, to provide electricity from the power generation sources 102 to the SDES system 160, to provide electricity from the grid 115 to the SDES system 160, to provide electricity from the SDES system 160 and the LODES system 104 to the power grid 115, and/or to provide electricity from the power generation sources 102, the SDES 160, and the LODES system 104 to the power grid 115. In various embodiments, the power generation source 102 may selectively charge the LODES 104 and/or SDES 160 and the LODES 104 and/or SDES 160 may selectively discharge to the power grid 115. In this manner, energy (e.g., renewable energy, non-renewable energy, etc.) generated by the power generation source 102 may be output to the power grid 115 sometime after generation from the LODES 104 and/or SDES 160.

In various embodiments, plant controller 112 may be in communication with a network 120 (e.g., 3G network, 4G network, 5G network, core network, Internet, combinations of the same, etc.). Using the connections to the network 120, the plant controller 112 may exchange data with the network 120 as well as devices connected to the network 120, such as a plant management system 121 or any other device connected to the network 121. The plant management system 121 may include one or more computing devices, such as computing device 124 and server 122. The computing device 124 and server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface enabling a user of the plant management system 121 to define inputs to the plant management system 121 and/or power generation system 101, receive indications associated with the plant management system 121 and/or power generation system 101, and otherwise control the operation of the plant management system 121 and/or the power generation system 101.

While illustrated as two separate devices, 124 and 122, the functionality of the computing device 124 and server 122 described herein may be combined into a single computing device or may split among more than two devices. Additionally, while illustrated as a dedicated part of the plant management system 121, the functionality of the computing device 124 and server 122 may be in whole, or in part, offloaded to a remote computing device, such as a cloud based computing system. While illustrated as in communication with a single power generation system 101, the plant management system 121 may be in communication with multiple power generation systems.

While illustrated as being geographically located together in FIG. 1, the power generation sources 102, the LODES system 104, and the SDES 160 may be separated from one another in various embodiments. For example, the LODES 104 may be downstream of a transmission constraint, such as downstream of a portion of the grid 115, etc., from the power generation source 102 and SDES 160. In this manner, the over build of underutilized transmission infrastructure may be avoided by situating the LODES 104 downstream of a transmission constraint, charging the LODES 104 at times of available capacity and discharging the LODES 104 at times of transmission shortage. The LODES 104 may also arbitrate electricity according to prevailing market prices to reduce the final cost of electricity to consumers.

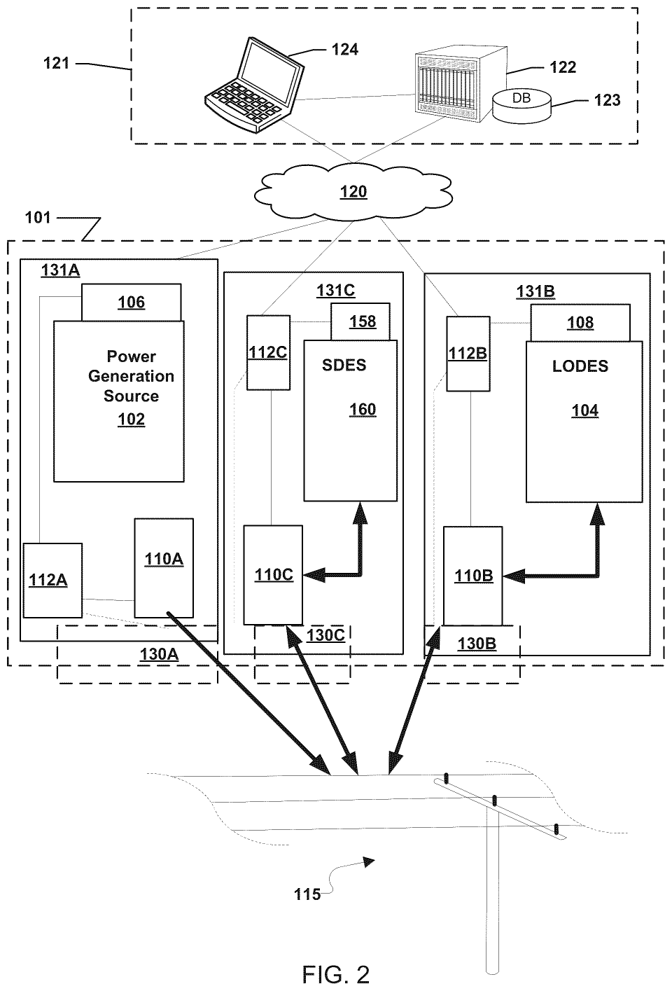

FIG. 2 illustrates an example of a power generation system 101 in which the power generation sources 102 and the bulk energy storage systems, such as the LODES system 104 and/or the SDES system 160, may be separated from one another according to various embodiments. With reference to FIGS. 1-2, FIG. 2 is similar to FIG. 1, except the power generation source 102, LODES 104, and SDES 160 may be separated in different plants 131A, 131B 131C, respectively. While the plants 131A, 131B, 131C may be separated, the power generation system 101 and the plant management system 121 may operate as described above with reference to FIG. 1. The plants 131A, 131B, and 131C may be co-located or may be geographically separated from one another. The plants 131A, 131B, and 131C may connect to the power grid 115 at different places. For example, the plant 131A may be connected to the grid upstream of where the plant 131B is connected. The plant 131A associated with the power generation sources 102 may include its own respective plant controller 112A and its own respective power control devices 110A and/or transmission facilities 130A. The power control devices 110A and/or transmission facilities 130A may be connected to the plant controller 112A. The plant controller 112A may monitor and control the operations of the power control devices 110A and/or transmission facilities 130A, such as via various control signals. As examples, the plant controller 112A may control the power control devices 110A and/or transmission facilities 130A to provide electricity from the power generation sources 102 to the power grid 115, etc.

The plant 131B associated with the LODES system 104 may include its own respective plant controller 112B and its own respective power control devices 110B and/or transmission facilities 130B. The power control devices 110B and/or transmission facilities 130B may be connected to the plant controller 112B. The plant controller 112B may monitor and control the operations of the power control devices 110B and/or transmission facilities 130B, such as via various control signals. As examples, the plant controller 112B may control the power control devices 110B and/or transmission facilities 130B to provide electricity from the LODES system 104 to the power grid 115 and/or to provide electricity from the grid 115 to the LODES system 104, etc. The plant 131C associated with the SDES system 160 may include its own respective plant controller 112C and its own respective power control devices 110C and/or transmission facilities 130C. The power control devices 110C and/or transmission facilities 130C may be connected to the plant controller 112C. The plant controller 112C may monitor and control the operations of the power control devices 110C and/or transmission facilities 130C, such as via various control signals. As examples, the plant controller 112C may control the power control devices 110C and/or transmission facilities 130C to provide electricity from the SDES system 160 to the power grid 115 and/or to provide electricity from the grid 115 to the SDES system 160, etc.

The respective plant controllers 112A, 112B, 112C and respective transmission facilities 130A, 130B, 130C may be similar to the plant controller 112 and transmission facilities 130 described with reference to FIG. 1.

In various embodiments, the respective plant controllers 112A, 112B, 112C may be in communication with the network 120. Using the connections to the network 120, the respective plant controllers 112A, 112B, 112C may exchange data with the network 120 as well as devices connected to the network 120, such as a plant management system 121, each other, or any other device connected to the network 121. In various embodiments, the operation of the plant controllers 112A, 112B, 112C may be monitored by the plant management system 121 and the operation of the plant controllers 112A, 112B, 112C, and thereby the power generation system 101, may be controlled by the plant management system 121.

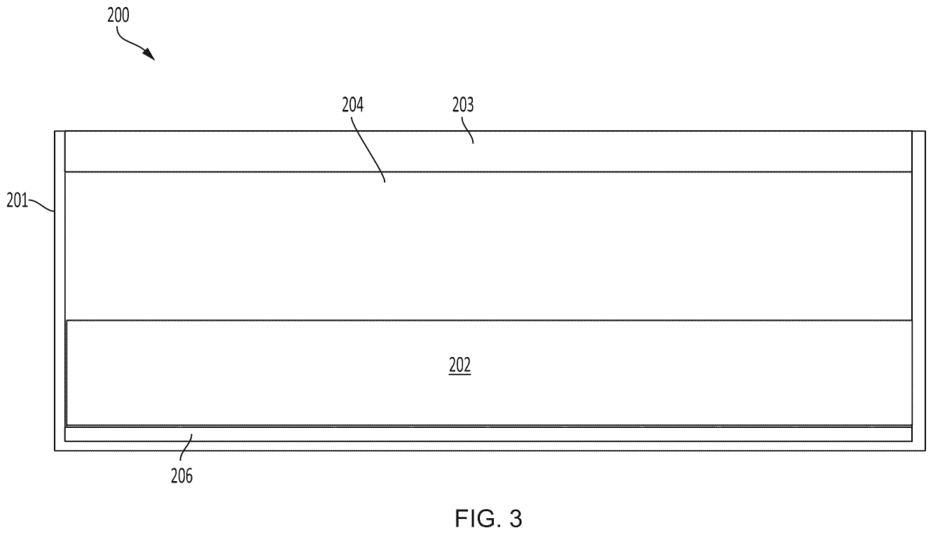

FIG. 3 is a schematic view of a battery 200, according to various embodiments of the present disclosure. With reference to FIGS. 1-3, the battery 200 may be one type of battery that may be used in a LODES 104 in various embodiments. Referring to FIG. 3, the battery 200 includes a vessel 201 in which an air electrode 203 (e.g., a cathode), a negative electrode 202 (e.g., an anode), an electrolyte 204, and a current collector 206 are disposed. The negative electrode 202 may be a metal electrode, such as an iron electrode, lithium electrode, zinc electrode, or other type suitable metal. The liquid electrolyte 204 may separate the air electrode 203 from the negative electrode 202. As examples, the battery 200 may be a metal-air type battery, such as an iron-air battery, lithium-air battery, zinc-air battery, etc. While various examples are discussed with reference to metal-air batteries, other type batteries may be substituted in the various examples and used in the various embodiments. The battery 200 may represent a single cell or unit, and multiple batteries 200 (or multiple units or cells) may be connected together to form battery strings (also referred to as modules).

In various embodiments, the negative electrode 202 may be solid and the electrolyte 204 may be excluded from the anode. In various embodiments the negative electrode 202 may be porous and the electrolyte 204 may be interspersed geometrically with the negative electrode 202, creating a greater interfacial surface area for reaction. In various embodiments, the air electrode 203 may be porous and the electrolyte interspersed geometrically with the negative electrode 203, creating a greater interfacial surface area for reaction. In various embodiments, the air electrode 203 may be positioned at the interface of the electrolyte and a gaseous headspace (not shown). In various embodiments, the gaseous headspace may be sealed in a housing. In various other embodiments, the housing may be unsealed and the gaseous headspace may be an open system which can freely exchange mass with the environment.

The negative electrode 202 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode or negative electrode 202 may be referred to as the metal electrode herein.

In certain embodiments, the battery may be rechargeable and the metal electrode may undergo a reduction reaction when the battery is charged. The anode 202 may be a solid, including a dense or porous solid, or a mesh or foam, or a particle or collection of particles, or may be a slurry, ink, suspension, or paste deposited within the housing. In various embodiments, the anode 202 composition may be selected such that the anode 202 and the volume of liquid electrolyte 204 may not mix together. For example, the anode 202 may be a metal electrode that may be a bulk solid. As another example, the anode 202 may be a collection of particles, such as small or bulky particles, within a suspension that are not buoyant enough to escape the suspension into the electrolyte. As another example, the anode 202 may be formed from particles that are not buoyant in the electrolyte.

The air electrode 203 may support the reaction with oxygen on the positive electrode. The cathode 203 may be a so-called gas diffusion electrode (GDE) in which the cathode is a solid, and it sits at the interface of a gas headspace and the electrolyte 204. During the discharge process, the cathode 203 supports the reduction of oxygen from the gaseous headspace, the so-called Oxygen Reduction Reaction (ORR). In certain embodiments, the battery 200 is rechargeable and the reverse reaction occurs, in which cathode 203 supports the evolution of oxygen from the battery, the so-called Oxygen Evolution Reaction (OER). The OER and ORR reactions are commonly known to those skilled in the art.

In various embodiments the electrolyte 204 is a liquid. In certain embodiments, the electrolyte 204 may be an aqueous solution, a non-aqueous solution, or a combination thereof. In various embodiments the electrolyte 204 is an aqueous solution which may be acidic (low-pH), neutral (intermediate pH), or basic (high pH; also called alkaline or caustic). In certain embodiments the liquid electrolyte 204 may comprise an electropositive element, such as Li, K, Na, or combinations thereof. In some embodiments, the liquid electrolyte may be basic, namely with a pH greater than 7. In some embodiments the pH of the electrolyte is greater than 10, and in other embodiments, greater than 12. For example, the electrolyte 204 may comprise a 6M (mol/liter) concentration of potassium hydroxide (KOH). In certain embodiments, the electrolyte 204 may comprise a combination of ingredients such as 5.5M potassium hydroxide (KOH) and 0.5M lithium hydroxide (LiOH). In certain embodiments the electrolyte 140 may comprise a 6M (mol/liter) concentration of sodium hydroxide (NaOH). In certain embodiments the electrolyte 140 may comprise a 5M (mol/liter) concentration of sodium hydroxide (NaOH) and 1M potassium hydroxide (KOH).

In certain embodiments, the battery 200 (e.g., metal-air battery) discharges by reducing oxygen (O₂) typically sourced from air. This requires a triple-phase contact between gaseous oxygen, an electronically active conductor which supplies the electrons for the reduction reaction, and an electrolyte 140 which contains the product of the reduction step. For example, in certain embodiments involving an aqueous alkaline electrolyte, oxygen from air is reduced to hydroxide ions through the half-reaction O₂+2H₂O+4e⁻→4OH⁻. Thus, oxygen delivery to metal-air cells requires gas handling and maintenance of triple-phase points. In certain embodiments, called “normal air-breathing” configurations, the cathode 203 may be mechanically positioned at the gas-liquid interface to promote and maintain triple-phase boundaries. The cathode 203 may be positioned vertically or horizontally, or at any intermediate angle with respect to gravity, and maintain a “normal air-breathing” configuration. In these “normal air-breathing” configurations, the gas phase is at atmospheric pressure (i.e., it is unpressurized beyond the action of gravity).

The configuration of the electrochemical cell (or battery 200) in FIG. 3 is merely an example of one electrochemical cell configuration according to various embodiments and is not intended to be limiting. Other configurations, such as electrochemical cells with different type vessels and/or without the vessel 201, electrochemical cells with different type air electrodes and/or without the air electrode 203, electrochemical cells with different type current collectors and/or without the current collector 206, electrochemical cells with different type negative electrodes and/or without the negative electrode 202, and/or electrochemical cells with different type electrolytes and/or electrochemical cells without liquid electrolyte 204 may be substituted for the example configuration of the battery 200 shown in FIG. 3 and other configurations are in accordance with the various embodiments.

In various embodiments, the vessel 201 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments the vessel 201 and/or housing for the electrochemical cell 200 may be made from a metal such as nickel, steel, anodized aluminum, nickel coated steel, nickel coated aluminum or other metal.

In various embodiments, a battery (e.g., battery 200) may include three electrodes—an anode (e.g., 202) and a dual cathode (e.g., cathode 203 constituted in two parts, such as a first cathode, and a second cathode). The electrodes may have finite useful lifetimes, and may be mechanically replaceable. For example, the anode may be replaced seasonally. The first cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion may be a microporous layer (MPL) of polytetrafluorethylene (PTFE) and high surface area carbon while the first portion may be carbon fiber partially coated with PTFE. As another example, the second portion may be a MPL of PTFE and carbon black and the first portion may be PTFE of approximately 33% by weight. As a further example, the second portion may be an MPL of 23% by weight PTFE and 77% by weight carbon black and the first portion may be a low loading MPL. The anode may be an iron (Fe) electrode or an iron-alloy (Fe-alloy) electrode (e.g., FeAl, FeZn, FeMg, etc.). The second cathode may have a hydrophilic surface. The second cathode may have a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may be comprised of a number of cells connected in series and/or parallel in a shared electrolyte bath, and contained in a housing.

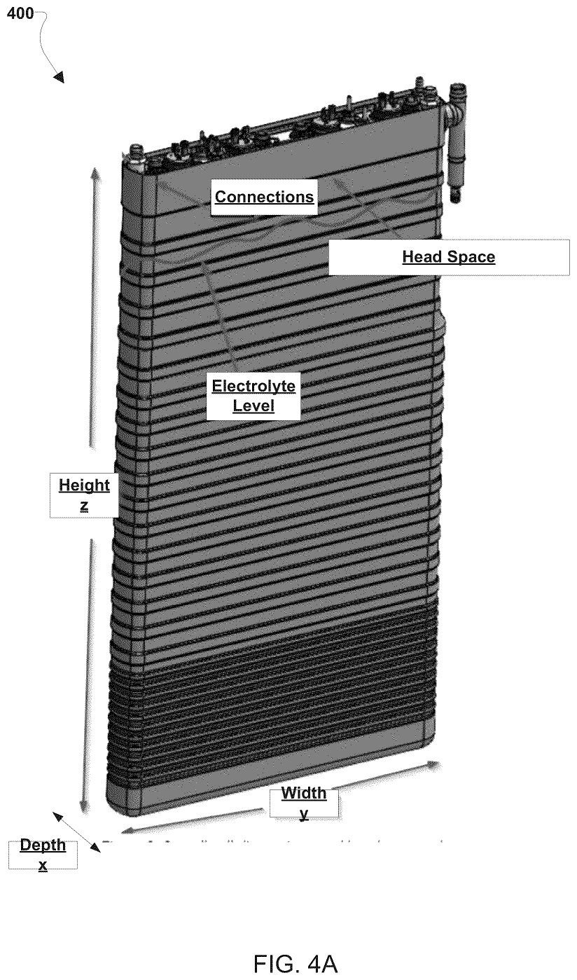

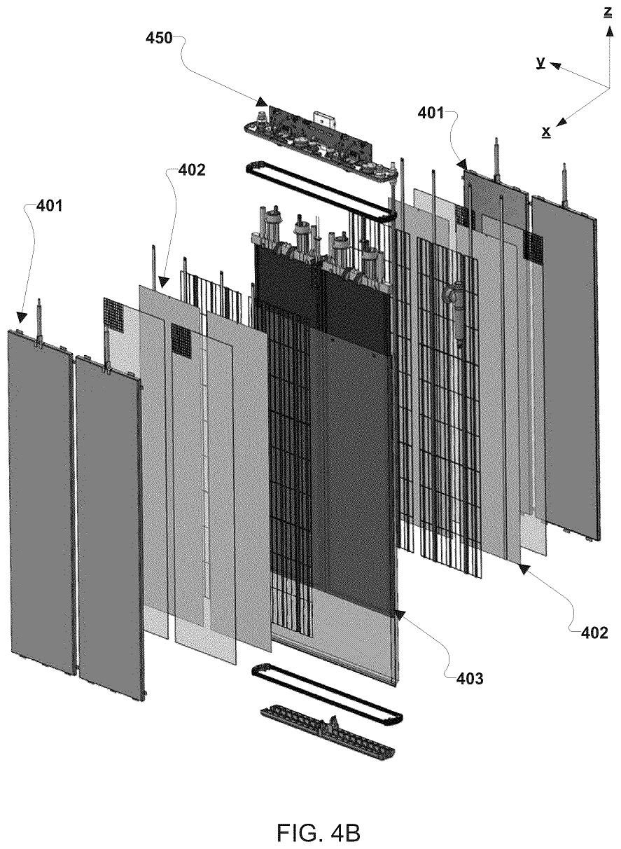

FIG. 4A is a schematic diagram of an example single electrochemical cell (or battery) enclosure 400 in accordance with various embodiments. With reference to FIGS. 1-4A, the enclosure 400 may include a battery, such as battery 200, in accordance with various embodiments. In some implementations, the enclosure 400 may be the vessel, such as vessel 201, in which an air electrode (e.g., a cathode), such as air electrode 203, a negative electrode (e.g., an anode), such as negative electrode 202, and an electrolyte, such as electrolyte 204, are disposed. The electrolyte, such as electrolyte 204, may rise to a given level within the enclosure 400 and a headspace between the top of the enclosure 400 and electrolyte level may be formed in the enclosure 400. The enclosure 400 may have a height (e.g., a z dimension), a width (e.g., a y dimension), and a depth (e.g., a x dimension). In one example, configuration, the height may be greater than the width and depth and the width may be greater than the depth such that the enclosure 400 is a generally rectangular cuboid. The enclosure 400 may include one or more various connections, such as electrical connections, electrolyte connections, gas connections (e.g., air connections), vents, etc. Via the connections, two or more electrochemical cells (or batteries) may be connected together, such as in series and/or in parallel, to form a module.

Each cell/battery enclosure, such as enclosure 400, in a module may be a self-contained unit supporting its own respective air electrode (e.g., air electrode 203), negative electrode (e.g., negative electrode 202), and electrolyte (e.g., electrolyte 204) volume. The module structure may support the cell enclosures, such as enclosures 400, disposed within the module.

FIG. 4B is an exploded view diagram of portions of an inside of the example electrochemical cell (or battery) enclosure 400 showing one example configuration of an electrochemical cell (or battery) in accordance with various embodiments. With reference to FIGS. 1-4B, the enclosure 400 may have within it various electrochemical cell (or battery) elements including one or more anode assemblies 401, such as one or more negative electrodes 202, one or more cathode assemblies, such as a cathode 203, and electrolyte, such as electrolyte 204. The configuration in FIG. 4B illustrates a two part cathode in which the cathode assembly includes an Oxygen Evolution Electrode (OEE) 402 and a separate gas diffusion electrode (GDE) 403. A battery configuration includes at least one OEE 402 and at least one GDE 403 may be referred to as a multi-cathode battery cell. The OEE 402 may be disposed within the enclosure between an anode assembly 401 and the GDE 403. The GDE 403 may be disposed in the center of the enclosure 400 and an additional GDE 403 and anode assembly 401 pair may be in a mirror configuration on the opposite side of the GDE 403. Air may enter the enclosure 400 and pass into the center of the GDE 403. Thus, in an example configuration, each electrochemical cell (or battery) enclosure 400 may include opposite side anode assemblies 401 each with their own respective OEE 402 in board of the respective anode assemblies 401, with a central GDE 403 with air passage down the center between the two OEEs 402. However, such internal cell (or battery) structure is merely one example configuration of the cell (or battery) that may be within an example enclosure, such as enclosure 400, and is not intended to be limiting. Additionally, the enclosure 400 may include one or more cell electronics structures 450, such as a printed circuit board assembly (PCBA), circuitry housing, etc., supporting various electronic devices, such as controllers, sensors, switches, wiring buses, etc., that may control and/or manage operations of the multi-cathode battery cell.

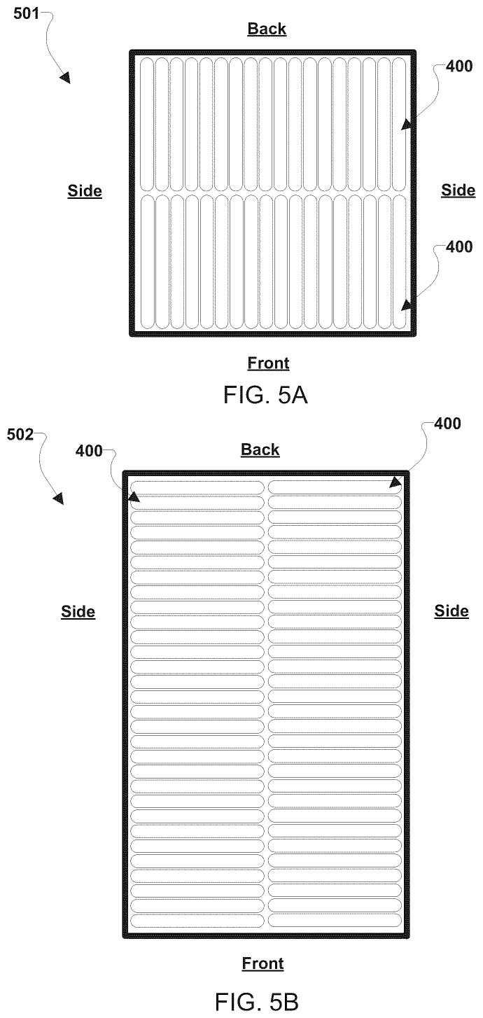

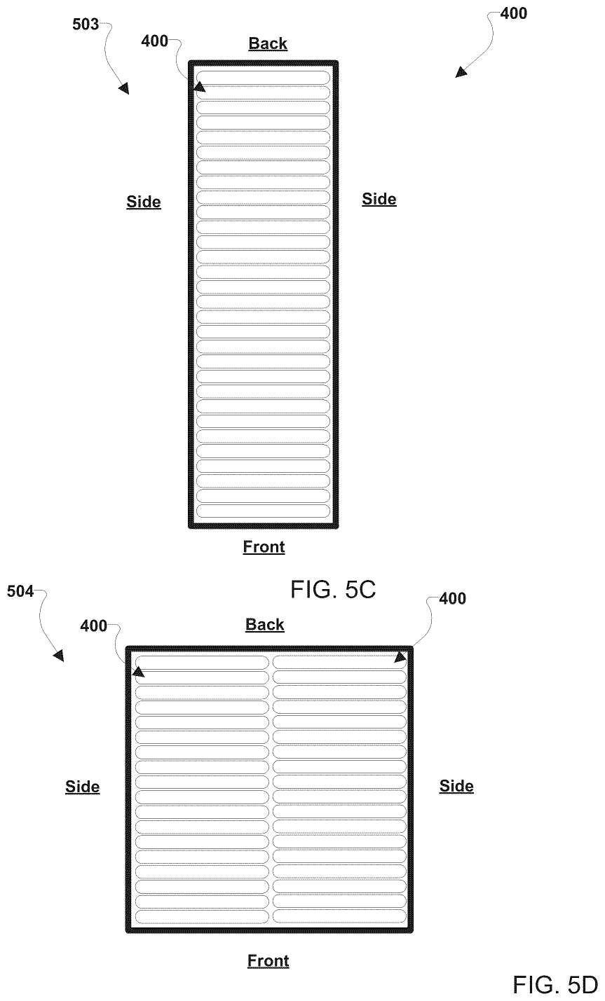

FIG. 5A is a schematic diagram of an example module 501 configuration including multiple electrochemical cell enclosures 400 in accordance with various embodiments. With reference to FIGS. 1-5A, the module 501 is shown from an overhead view looking down the height (e.g., z dimension) of the cell enclosures 400. The module 501 configuration may be a generally cubic configuration with the front, back, and sides of the module 501 about the same lengths. In the module 501, two rows of cell enclosures 400 may be arranged such that the widths of the cell enclosures 400 run parallel to the sides of the module 501 and the depths of the cell enclosures 400 run parallel to the front and back of the module 501. In the configuration of the module 501, the widths of the two cell enclosures 400 may generally govern the length of the sides of the module 501 along with any spacing between the rows of enclosures 400 and spacing of the respective rows and the front and back of the module 501. The number enclosures 400 in each row and the depth of the enclosures 400 may generally govern the length of the front and back of the module 501 along with the spacing between the enclosures 400 in each row and the spacing of the respective rows and the sides of the module 501.

FIG. 5B is a schematic diagram of another example module 502 configuration including multiple electrochemical cell enclosures 400 in accordance with various embodiments. With reference to FIGS. 1-5B, the module 502 is shown from an overhead view looking down the height (e.g., z dimension) of the cell enclosures 400. The module 502 configuration may be a generally rectangular configuration with the sides of the module 502 longer than the back and front of the module 502. In the module 502, two rows of cell enclosures 400 may be arranged such that the widths of the cell enclosures 400 run parallel to the front and back of the module 502 and the depths of the cell enclosures 400 run parallel to the sides of the module 502. In the configuration of the module 502, the widths of the two cell enclosures 400 may generally govern the length of the front and back of the module 502 along with any spacing between the rows of enclosures 400 and spacing of the respective rows and the sides of the module 502. The number of enclosures 400 in each row and the depth of the enclosures 400 may generally govern the length of the sides of the module 502 along with the spacing between the enclosures 400 in each row and the spacing of the respective rows and the front and back of the module 502.

FIG. 5C is a schematic diagram of another example module 503 configuration including multiple electrochemical cell enclosures 400 in accordance with various embodiments. With reference to FIGS. 1-5C, the module 503 is shown from an overhead view looking down the height (e.g., z dimension) of the cell enclosures 400. The module 503 configuration may be a generally rectangular configuration with the sides of the module 503 longer than the back and front of the module 503. In the module 503, a single row of cell enclosures 400 may be arranged such that the widths of the cell enclosures 400 run parallel to the front and back of the module 503 and the depths of the cell enclosures 400 run parallel to the sides of the module 502. In the configuration of the module 503, the widths of the single row of cell enclosures 400 may generally govern the length of the front and back of the module 503 along with any spacing between the sides of the module 503. The number enclosures 400 in the row and the depth of the enclosures 400 may generally govern the length of the sides of the module 503 along with the spacing between the enclosures 400 in the row and the spacing between the front and back of the module 503.

FIG. 5D is a schematic diagram of another example module 504 configuration including multiple electrochemical cell enclosures 400 in accordance with various embodiments. With reference to FIGS. 1-5D, the module 504 is shown from an overhead view looking down the height (e.g., z dimension) of the cell enclosures 400. The module 504 configuration may be a generally cubic configuration with the front, back, and sides of the module 501 about the same lengths. In the module 504, two rows of cell enclosures 400 may be arranged such that the widths of the cell enclosures 400 run parallel to the front and back of the module 504 and the depths of the cell enclosures 400 run parallel to the sides of the module 502. In the configuration of the module 504, the widths of the two cell enclosures 400 may generally govern the length of the front and back of the module 504 along with any spacing between the rows of enclosures 400 and spacing of the respective rows and the sides of the module 504. The number enclosures 400 in each row and the depth of the enclosures 400 may generally govern the length of the sides of the module 504 along with the spacing between the enclosures 400 in each row and the spacing of the respective rows and the front and back of the module 504.

The configuration of the modules 501-504 in FIGS. 5A-5D are merely example modules including multiple electrochemical cell configurations according to various embodiments and are not intended to be limiting. Other configurations, such modules with more or less rows, modules with no-linear configurations, modules with more or less cells, etc., may be substituted for the example configuration of the modules 501-504 and other configurations are in accordance with the various embodiments.

In various embodiments, battery modules having strings of cells therein, such as modules 501-504, may be enclosed in a module enclosure. A module enclosure may house one or more modules, modules having strings of cells therein, such as modules 501-504.

Modules, such as modules 501-504, deployed in the field may need protection from the elements, such as: wind, dust, snow, rain, seismic activity, etc. The modules, such as modules 501-504, may also need to be secured to the ground to prevent movement in the event of heavy winds and/or seismic activity. Personnel also need to have protections from high voltage, caustic fluids, and any other hazardous conditions associated with the operation of a battery system. There are several auxiliary systems that will also need support for operating the battery energy storage system, including secondary containment, thermal management, hydrogen management, gas diffusion electrode (GDE) support, air supply, electrolyte/water management, etc. Enclosures may be configured in accordance with various embodiments, to provide such support to one or more modules, such as modules 501-504, in a battery system.

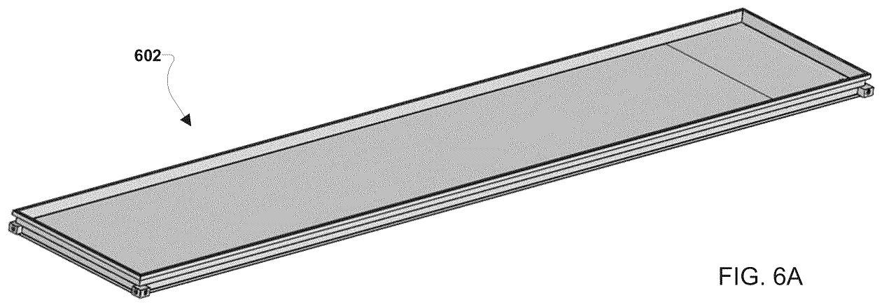

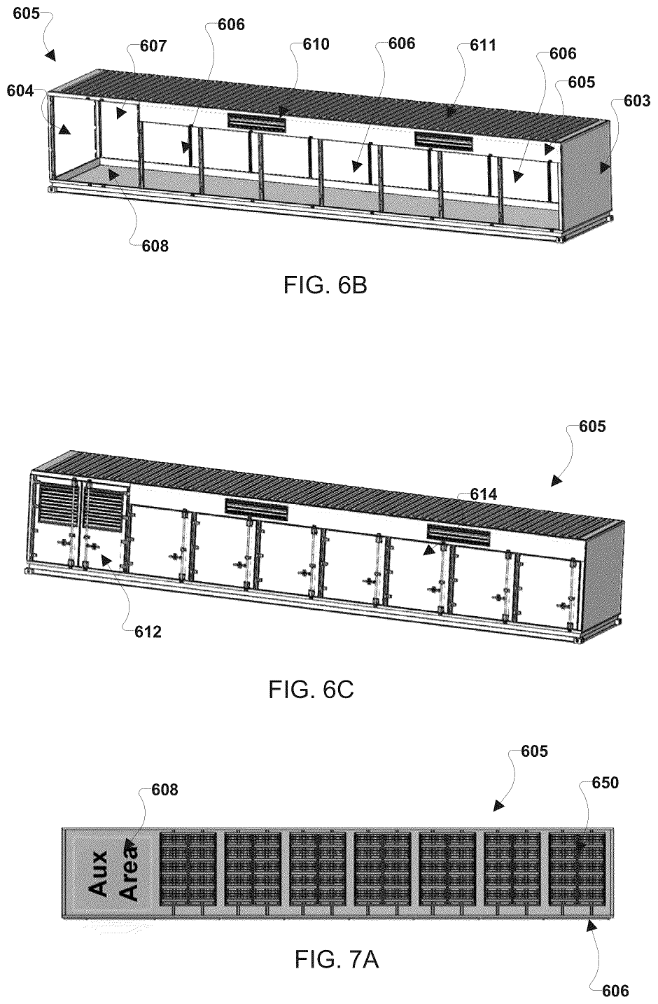

FIGS. 6A-6C illustrate portions of an example enclosure 605 for one or more modules, such as modules 501-504, in a battery system. With reference to FIGS. 1-6C, FIG. 6A illustrates a lower structure 602 of the enclosure 605, FIG. 6B illustrates the enclosure 605 with doors 612 and 614 removed, and FIG. 6C illustrates the enclosure 605 with the doors 612 and 614 installed. Additionally, other doors and/or hatches may be installed along other walls and/or the roof of the enclosure 605. In various embodiments, the lower structure 602 may support the entire weight of the battery modules for transport and installation. A secondary containment may be fabricated into the lower structure 602, for example to handle both the potential for a spill and fire water if it is incorporated in the design. Lifting points will be provided in the lower structure 602 as it can be lifted either by the corners or have additional pick points incorporated along its length. The base of the lower structure 602 may include attachment points to secure the battery modules, such as modules 501-504, to the enclosure 605, for example to support shipping, seismic event dampening, etc. In various embodiments, the enclosure 605 may include any number of modules, such as modules 501-504 therein. The configuration of the enclosure 605 illustrated in FIGS. 6A-6C shows a configuration for at least seven modules, such as modules 501-504, but more or less modules may be present in the enclosure depending on enclosure size and/or configuration. The enclosure 605 may include mounting points provided to attach to a variety of field installation structures, such as grade beams, piles, helical piers, foundations, etc., upon deployment in the field.

In some embodiments, the enclosure may include an auxiliary area 608. In some embodiments, the auxiliary area 608 may be located at one end of the enclosure in which auxiliary equipment to support the modules, such as modules 501-504, may be mounted. In other embodiments, the auxiliary area 608 may be located anywhere along the enclosure, such as in the middle of the enclosure, in a first third of the enclosure, etc., and the modules, such as modules 501-504 may be located on either side of the auxiliary area. Auxiliary equipment may include, pumps, blowers, controllers, switches, connections, tubing, ducting, heaters, chillers, filters, reservoirs, tanks, electronics, or any other type equipment that may support the operation of the modules, such as modules 501-504, within the enclosure 605. The support subsystems may be housed in the auxiliary area 608 and connected to the modules, such as modules 501-504. The support subsystems may include GDE air systems, thermal management systems, heating systems, hydrogen management systems, water and/or electrolyte management systems, power electronics systems, controls electronics systems, communication systems, telemetry sensors and equipment, and/or disconnects from plant level services, as well as any other type of subsystems.

The floor of the enclosure 605 may also have perforations to allow for stub ups of electrical, water, or any other desired connection to be made upon installation in the field as long as the perforation is properly designed to maintain the secondary containment requirements of the lower structure.

As illustrated in FIGS. 6B and 6C, walls 603, 604, 605, and 607 may be attached to the lower structural base 602, and designed to support any snow loads taken up by the roof 611, as well being designed to handle wind loads. This structural shell may also provide for mounting any of the auxiliary subsystems that need to be run throughout the enclosure 605. While illustrated as metal walls 603, 604, 605, and 607 and roof 611, all or portions of the walls and/or roof may be formed from other materials, such as fabric, cloth, etc. In various configurations, the enclosure may be formed into different areas, such as the auxiliary area 608 and module bays 606. In various embodiments, the auxiliary area 608 may be covered by a door 612 on one or both long sides of the enclosure 605 and module bays 606 may be covered by doors 614 on one or both long sides of the enclosure 605. The doors 612 and/or 614 may enable access to the auxiliary equipment and/or modules for servicing and/or replacement. In some embodiments, perforations 610 may be present in the side walls 605 and/or roof 611 to allow for air to be exchanged from ambient to the enclosure 605 and vice versa. Filter grates may be one example of the perforations 610. The configuration of the enclosure 605 may maintain low dust intrusion and/or protect against driven rain.

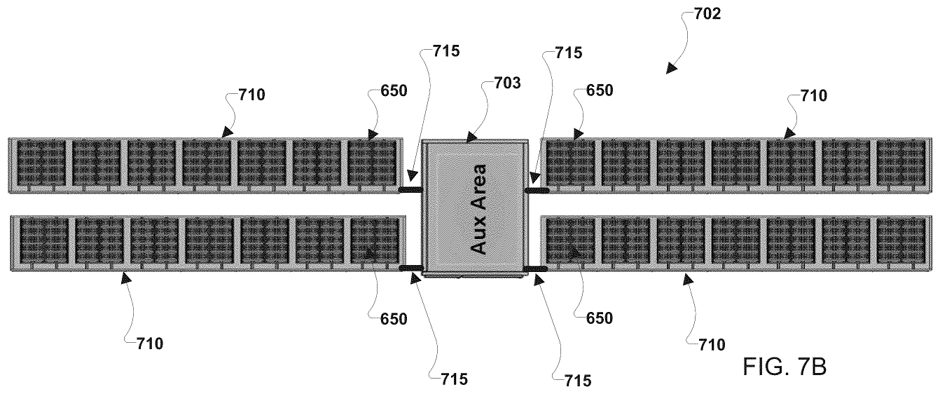

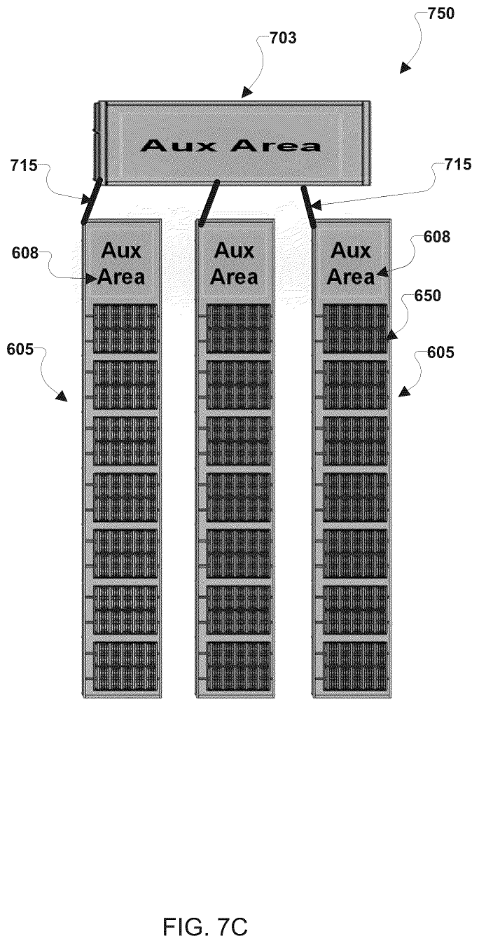

FIGS. 7A-7C illustrate battery module enclosure configurations in accordance with various embodiments. With reference to FIGS. 1-7C, FIG. 7A illustrates a top down view of example enclosure 605 in which the auxiliary area 608 is within the enclosure 605 and co-located with the modules 650, such as modules 501-504, within the module bays 606. While seven sets of modules are illustrated in FIG. 7A, this is merely one example, and more or less modules may be present in the enclosure 605.

FIG. 7B illustrates an alternative configuration 702 in which the enclosures 710 supporting the modules 650, such as modules 501-504, may not include auxiliary areas therein, and rather a central auxiliary area 703 may support one or more enclosures 710. This separate auxiliary area 703 enclosure may be connected to the modules by one or more connections 715 and the auxiliary area 703 may feed the subsystem services, such as those of GDE air systems, thermal management systems, hydrogen management systems, water and/or electrolyte management systems, power electronics systems, controls electronics systems, telemetry sensors and equipment, and/or disconnects from plant level services, as well as any other type subsystems, to the enclosures 710 and the modules 650 therein. While four enclosures 710 are illustrated in FIG. 7B, more or less enclosures 710 may be connected to the auxiliary area 703 and the auxiliary area 703 may be sized according to the number of enclosures to support and number of modules within the enclosures.

FIG. 7C illustrates an alternative configuration 750 in which a separate auxiliary area 703 enclosure is connected to the enclosures 605 which also have auxiliary areas 608 therein. In this manner, some auxiliary system functions may be in whole, or in part, offloaded to the separate auxiliary area 608 and some auxiliary system functions may in whole, or in part, remain at the enclosure 605 level.

While FIGS. 7A-7C illustrate various configurations for enclosures and/or auxiliary areas, the configurations illustrated in FIGS. 7A-7C are merely examples according to various embodiments and are not intended to be limiting. Other configurations of enclosures and/or auxiliary areas may be substituted for the example configuration of FIGS. 7A-7C and other configurations are in accordance with the various embodiments.

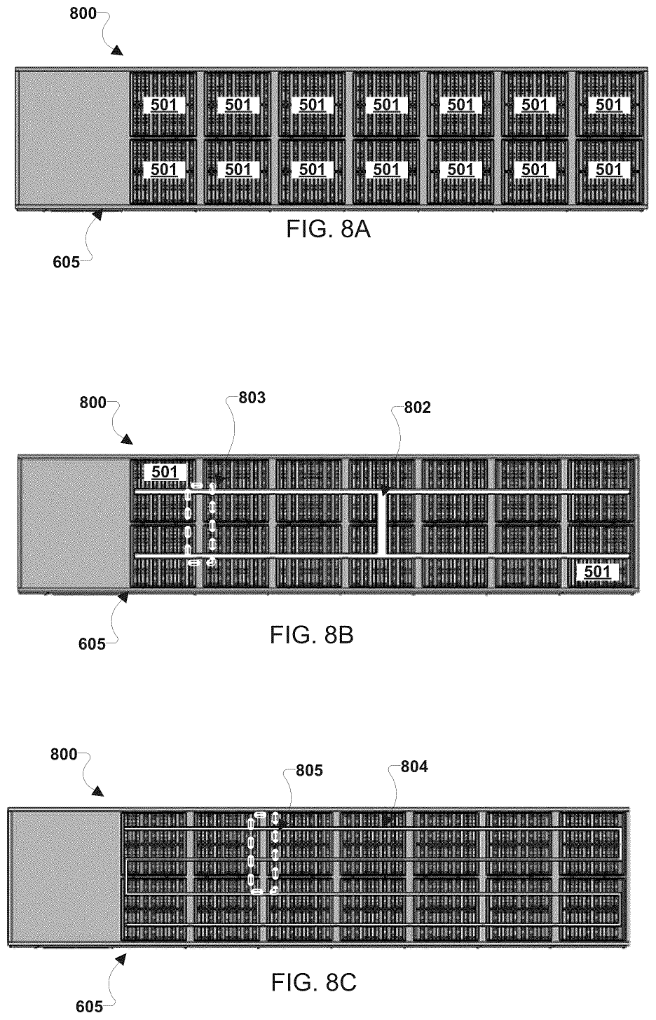

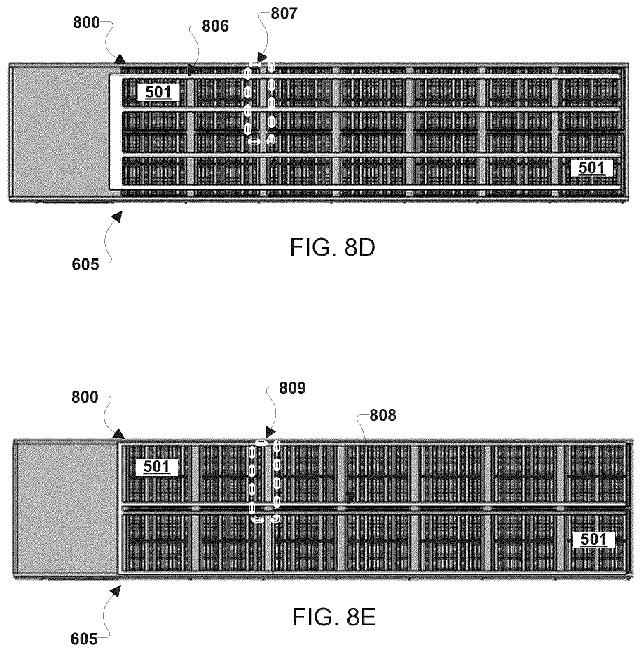

FIGS. 8A-8E illustrate an example module 501 layout 800 within an enclosure 605 in accordance with various embodiments. With reference to FIGS. 1-8E, FIGS. 8A-8E illustrate a layout 800 in which two modules 501 are arranged front to back within a module bay. In the layout 800, electrical routing may be provided and all hookups may be on the enclosure 605 short end. In the layout 800, space may be required within the enclosure 605 for module removal. In the layout 800, electrode width may be tied to the smallest enclosure 605 dimension. In the layout 800, thermal spacing may be tied to the smallest enclosure dimension. Layout 800 may require connection and/or disconnection of a back module 501 of the two modules 501 in each module bay. Layout 800 may require some activities of personnel to be performed in the enclosure.

FIG. 8B illustrates an example thermal management ducting/plumbing system configuration 803 and connections 804 needed to be made inside the enclosure 605 to install and/or remove a module 501. FIG. 8C illustrates an example electrical system connection configuration 804 and connections 805 needed to be made inside the enclosure 605 to install and/or remove a module 501. FIG. 8D illustrates an example GDE air system connection configuration 806 and connections 807 needed to be made inside the enclosure 605 to install and/or remove a module 501. FIG. 8E illustrates an example water and/or electrolyte system connection configuration 808 and connections 809 needed to be made inside the enclosure 605 to install and/or remove a module 501.

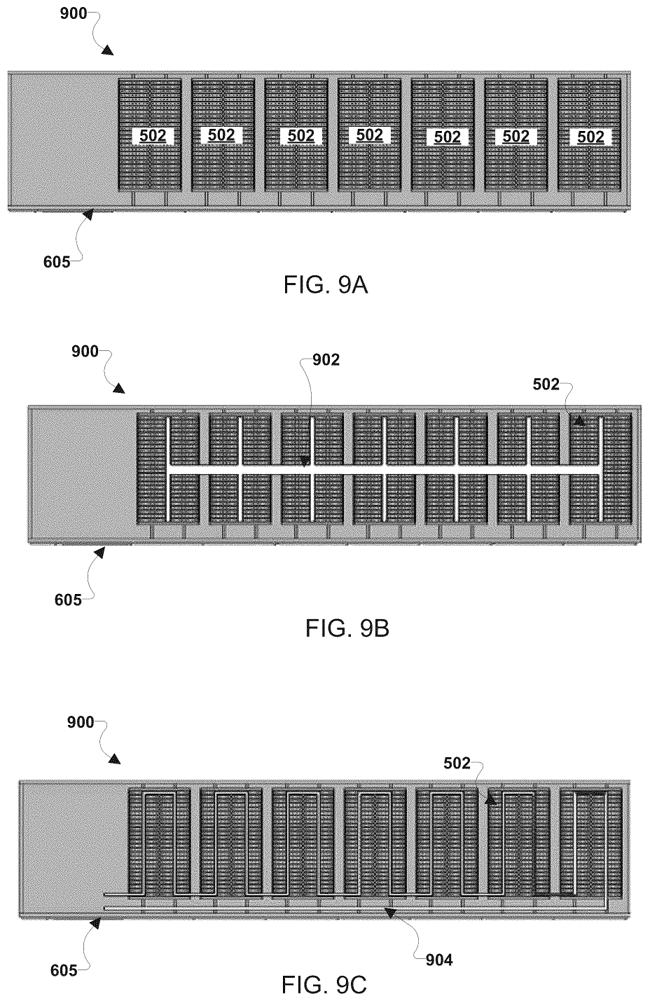

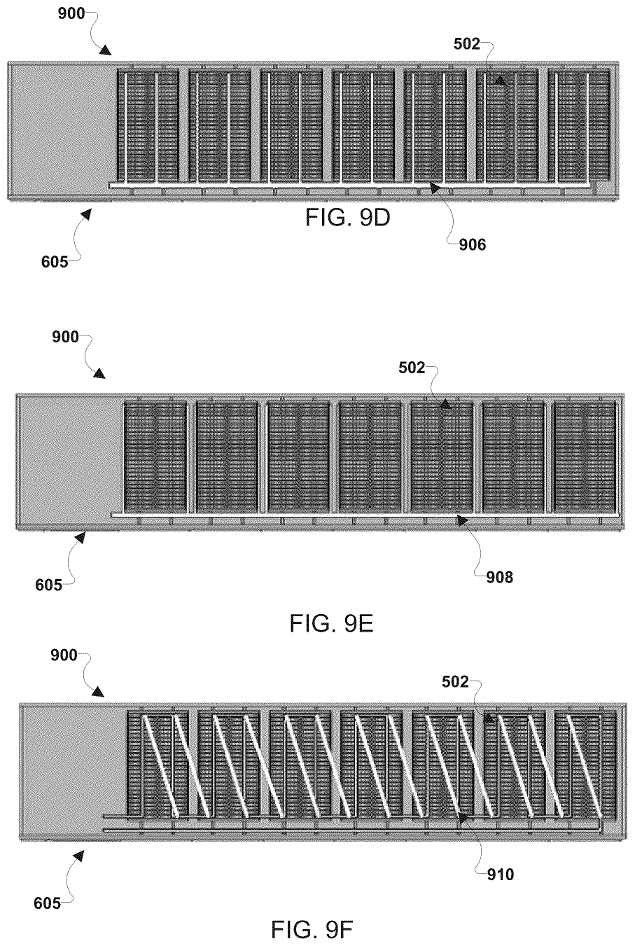

FIGS. 9A-9F illustrate an example module layout 900 within an enclosure 605 in accordance with various embodiments. With reference to FIGS. 1-9F, FIGS. 9A-9F illustrate a layout 900 in which a module 502 may be arranged within each module bay. In the layout 900, the module connections may be at the doors of the module bays.

FIG. 9B illustrates an example thermal management ducting/plumbing system configuration 902 inside the enclosure 605. FIG. 9C illustrates an example electrical system connection configuration 904 inside the enclosure 605. FIG. 9D illustrates an example GDE air system connection configuration 906 inside the enclosure 605. FIG. 9E illustrates an example water and/or electrolyte system connection configuration 908 inside the enclosure 605. FIG. 9F illustrates an optional second electrical system connection configuration 910 (shown in white) including blind mating at the back of the modules 502 and front side connections.

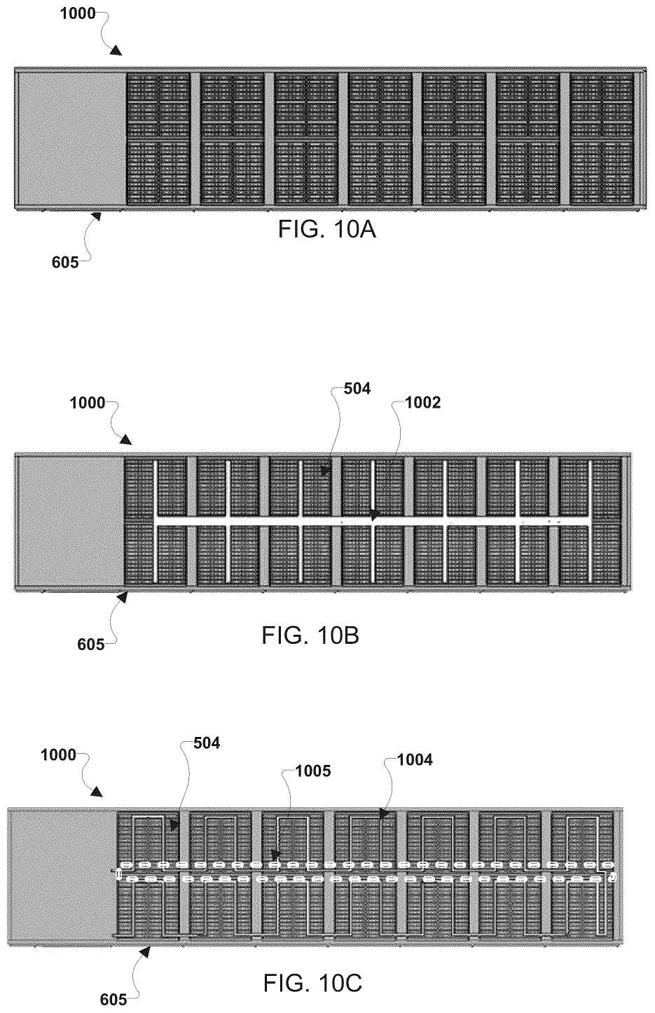

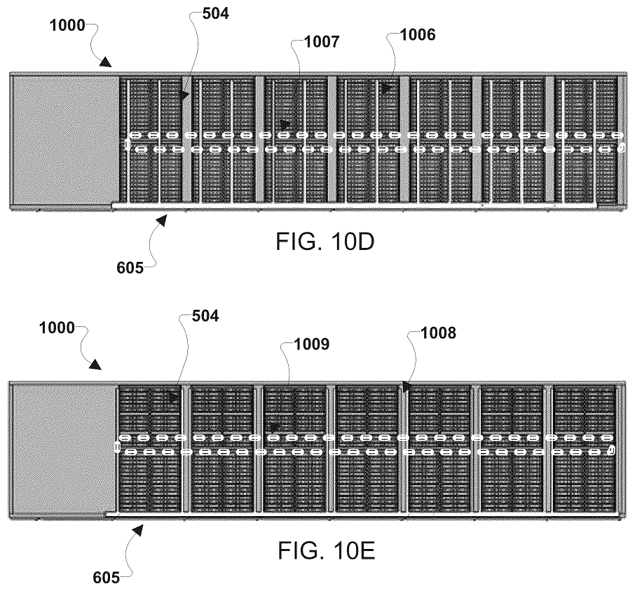

FIGS. 10A-10E illustrate an example module 504 layout 1000 within an enclosure 605 in accordance with various embodiments. With reference to FIGS. 1-10E, FIGS. 10A-10E illustrate a layout 1000 in which two modules 504 are arranged front to back within a module bay. In the layout 1000, space may be required within the enclosure 605 for module removal. In the layout 1000, electrode width may independent of enclosure 605 width. Layout 1000 may require connection and/or disconnection of a back module 504 of the two modules 504 in each module bay. Layout 1000 may require some activities of personnel to be performed in the enclosure.

FIG. 10B illustrates an example thermal management ducting/plumbing system configuration 1003 inside the enclosure 605. FIG. 10C illustrates an example electrical system connection configuration 1004 and connections 1005 needed to be made inside the enclosure 605 to install and/or remove a module 504. FIG. 10D illustrates an example GDE air system connection configuration 1006 and connections 1007 needed to be made inside the enclosure 605 to install and/or remove a module 504. FIG. 10E illustrates an example water and/or electrolyte system connection configuration 1008 and connections 1009 needed to be made inside the enclosure 605 to install and/or remove a module 504.

While FIGS. 8A-10E illustrate various configurations for enclosures and modules within those enclosures, the configurations illustrated in FIGS. 8A-10E are merely examples according to various embodiments and are not intended to be limiting. Other configurations for enclosures and modules within those enclosures may be substituted for the example configuration of FIGS. 8A-10E and other configurations are in accordance with the various embodiments. Additionally, while FIGS. 8A-10E illustrate example module layouts 800, 900, and 1000 showing an auxiliary area 608 within the enclosure, the configurations of the thermal management ducting/plumbing systems configurations and connections, electrical systems connection configurations and connections, GDE air systems configurations and connections, and/or water and/or electrolyte system configurations and connections may be similar configurations in which no auxiliary area is within the enclosures, such as configuration 702, and/or configurations in which the auxiliary area 608 is located within the central area of the enclosure between modules, such as between any two modules 501-504.

Various embodiments may provide control and/or sensing circuit configurations for electrochemical energy storage systems, such as metal-air battery systems. Various embodiments may include electrolyte fluid level sensors. Various embodiments may include cathode switching for multi-cathode battery cells.

Metal-air batteries, such as iron-air batteries, etc., may have multiple cathode terminals that may be designated for discharge and charging operations. These cathode terminals need to be managed to ensure that current only flows through the correct cathode during different operating conditions. Improper current regulation of these cathodes may lead to rapid cell performance degradation and/or safety issues.

In various embodiments, each cell enclosure, such as enclosures 400, may be equipped with electronics, such as mechanical relay switches, solid-state electronic switches, etc., to control which cathode, such as which of cathodes 402, 403, is active during current flow. In some embodiments, solid-state electronics switching devices, for example, semiconductor switches (e.g., metal-oxide-semiconductor field-effect transistors (MOSFETs), thyristors, etc.) or electro-mechanical switches may control which cathode, such as which of cathodes 402, 403, is active during current flow. Solid-state electronic switches may allow almost instantaneous transition between discharge and charge operations to mimic a standard two terminal battery cell. Cathode switches according to the various embodiments may be controlled by a battery management system, manually controlled by operators, and/or operate autonomously based on a measured current direction. As a multi-cathode cell has designated terminals for charging and discharging, by adding switches in-line with each cathode terminal the current flow through each terminal may be regulated.

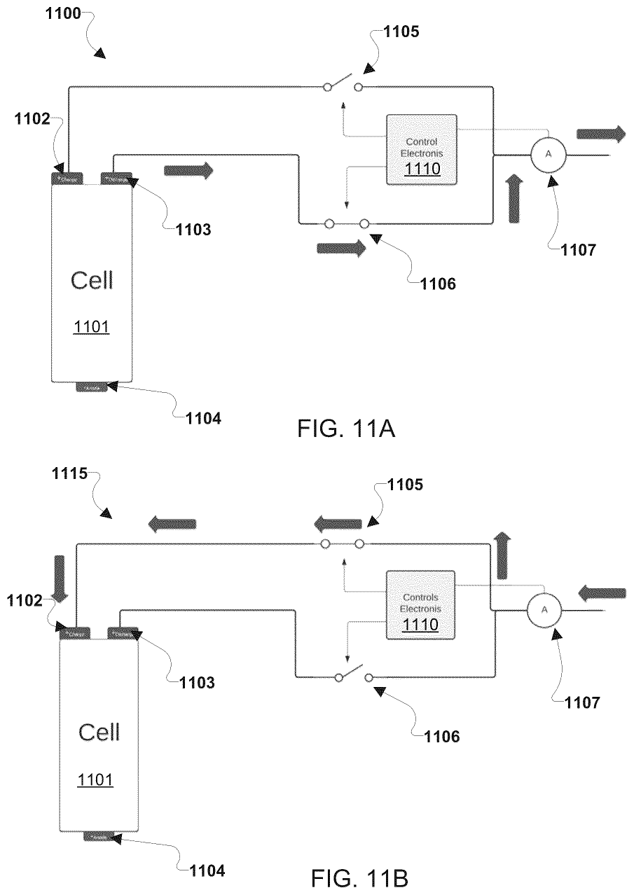

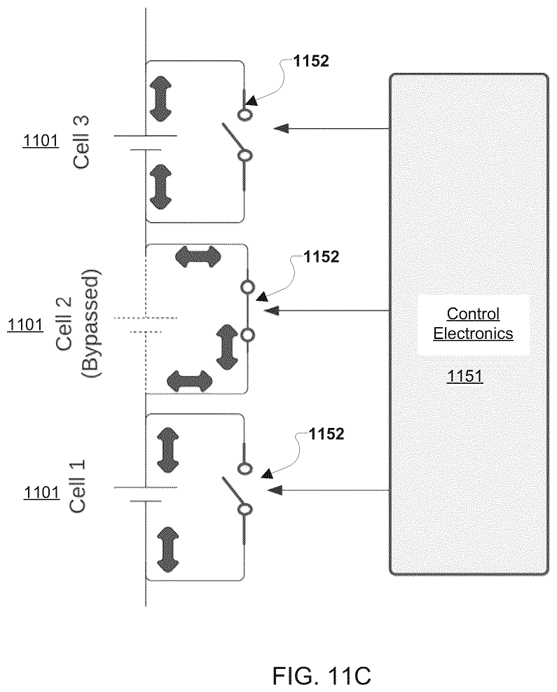

FIG. 11A illustrates an example of a cell discharging configuration 1100 for a multi-cathode battery cell 1101, such as the multi-cathode battery having an anode 401, OEE cathode 402, and a GDE cathode 403 housed within the enclosure 400 as described above. FIG. 11B illustrates the cell charging configuration 1115 for the cell 1101. With reference to FIGS. 1-11B, the components illustrated in FIGS. 11A and 11B may be portions of the electronics structures 450 connected to the enclosure 400.

In the cell 1101, an anode terminal 1104 may extend from the anode, such as anode 401, a charge terminal 1102 may extend from a charge cathode, such as OEE 402, and a discharge terminal 1103 may extend from a discharge cathode, such as GDE 403. A charge switch 1105, such as a mechanical relay, a semiconductor switch, etc., may be disposed between the charge terminal 1102 and the output positive cell terminal. A discharge switch 1106, such as a mechanical relay, a semiconductor switch, etc., may be disposed between the discharge terminal 1103 and the output positive cell terminal. The state of the charge switch 1105 and the discharge switch 1106 may be controlled by control electronics 1110 which may be connected to a current sensor 1107 that may monitor the current of the output positive cell terminal of the cell 1101 and the control electronics 1110 may control the state of the charge switch 1105 and/or the discharge switch 1106 based on the current sensed by the current sensor 1107. Alternatively, the state of the charge switch 1105 may be controlled through an external request.

In the discharge configuration 1100, the charge switch 1105 may be opened and the discharge switch 1106 closed by the control electronics 1110 to cause current flow away from the discharge terminal 1103 and toward the output positive cell terminal, thereby discharging the cell 1101. In the charge configuration 1115, the discharge switch 1106 may be opened and the charge switch 1105 closed by the control electronics 1110 to cause current flow from the output positive cell terminal and toward the charging terminal 1102, thereby charging the cell 1101. The control electronics 1110 may monitor the current flow out of the cell 1101 and can switch the cell operation based on the current direction and/or from an external request. The current may be continuously monitored by the control electronics 1110 to ensure the cell 1101 is in the proper requested state, e.g., in a discharge state, in a charge state.

In various embodiments, cells, such as cell 1101, may be equipped with a bypass switch. FIG. 11C illustrates bypass operations in accordance with various embodiments in which each cell 1101 may be connected to a respective bypass switch 1152 controlled by control electronics 1151. With reference to FIGS. 1-11C, the control electronics 1151 may be portions of the electronics structures 450 connected to the enclosure 400 and/or may be control electronics operating at a module level, such as controllers within a module 501, 502, 503, 504, 650, etc. The bypass switch 1152 routes operating current around the cell 1101 and electrically removes it from the series cell circuit when the bypass switch 1152 is closed. The bypass switch 1152 may be a controllable switch, such as a mechanical relay, a semiconductor switch, etc. The bypass switch 1152 may be controlled and actuated by the control electronics 1151. The bypass switch 1152 can be used to skip damaged or poor performing cells 1101 without interrupting the rest of the system. The bypass switch 1152 may also be used to balance the capacity of each cell 1101 in a module (e.g., 501, 502, 503, 504, 650, etc.). For example, if a cell 1101 is fully charged it will be bypassed so that other cells 1101 can continue charging.

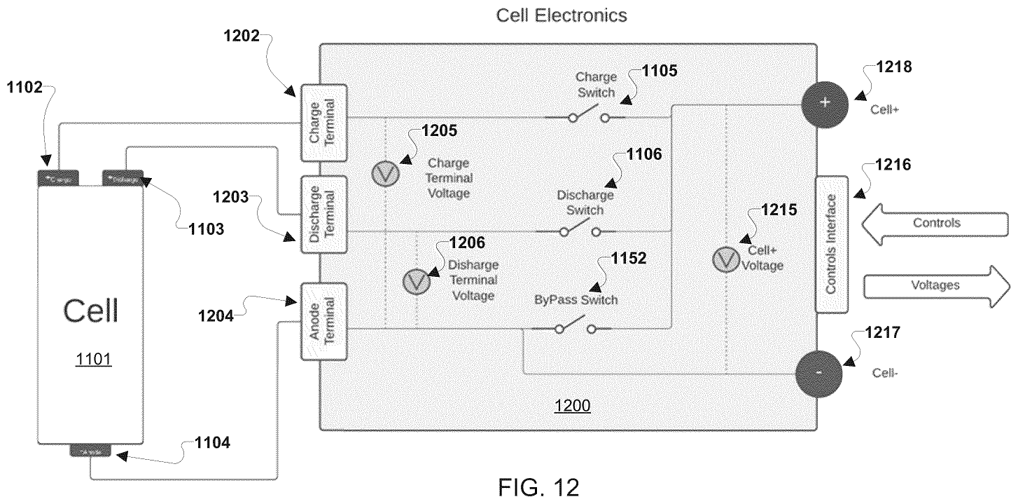

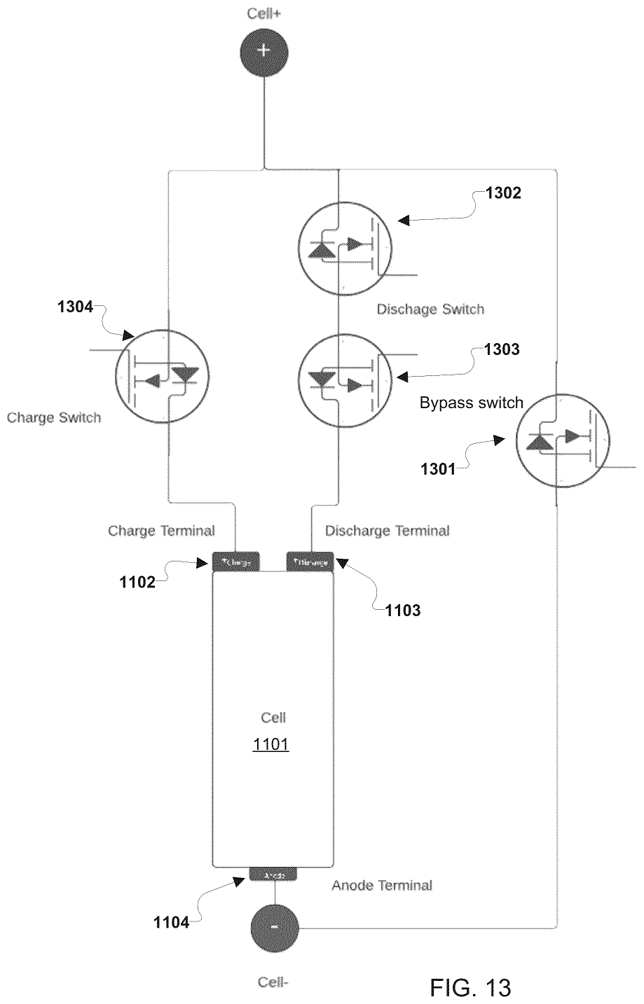

FIG. 12 is a circuit diagram of an example cell electronics 1200 configuration providing charging and discharging switching along with bypass switching in accordance with various embodiments. With reference to FIGS. 1-12, the components illustrated in FIG. 12 may be portions of the electronics structures 450 connected to the enclosure 400. As an example, the cell electronics 1200 may be a PCBA coupled to the enclosure 400.

As the multi-cathode cell 1101 has designated terminals for charging 1102 and discharging 1103, the switches 1105, 1106 in-line with each cathode terminal 1102, 1103, the current direction for each terminal 1102, 1103 can be regulated. The cell electronics 1200 may include a charge terminal 1202 connected to the cell 1101 charge terminal 1102, a discharge terminal 1203 connected to the cell 1101 discharge terminal 1103, and anode terminal 1204 connected to the anode terminal 1104 of the cell 1101. The cell electronics 1200 may include a controls interface 1216, an output positive cell terminal 1218, an output negative cell terminal 1217, and voltage signals of charge terminal 1202, discharge terminal 1203, and/or positive cell terminal 1218. The controls interface is responsible for receiving control commands which are then implemented in the cell electronics 1200 and transmitting signals (such as cell voltages, etc.) to other controls interfaces throughout the system. The output positive cell terminal 1218 may behave similar to a single cathode cell allowing for bi-directional current. A voltage sensor 1205 may be connected between the charge terminal 1202 and the anode terminal 1204 to measure the charge terminal voltage. A voltage sensor 1206 may be connected between the discharge terminal 1203 and the anode terminal 1204 to measure the discharge terminal voltage. A voltage sensor 1215 may be connected between the output positive cell terminal 1218 and the output negative cell terminal 1217 to measure the cell voltage. The charging switch 1105 and discharging switch 1106 may be controlled by the battery electronics which may be monitoring the current magnitude and direction of the cells 1101. Because all terminals 1202, 1203, 1204 have an inline switch 1105, 1106, 1152, all the switches 1105, 1106, 1152 can be controlled to open, which reduces the voltage and the corresponding electrical hazards.

In various embodiments, using solid-state semiconductor switches can reduce cost and improve reliability. With semiconductor switches it is important to consider the internal body-diode characteristics and how that impacts switching transients and operations. By having back-to-back semiconductor switches the current in both directions can be blocked. This also prevents unwanted discharging of the cell during balancing and bypass operations.

FIG. 13 is a circuit diagram of an example semiconductor based cell 1101 switching topology in accordance with various embodiments. With reference to FIGS. 1-13, the switching topology in FIG. 13 may be a specific example of an implementation of the cell electronics 1200 of FIG. 12 using MOSFETs to provide the switching capability. The charge switch 1105 may be a MOSFET 1304. The discharge switch 1106 may be two MOSFETs 1302 and 1303 arranged in back-to-back configuration. The bypass switch 1152 may be a MOSFET 1301.

Aqueous battery cells require management of their electrolyte fluid level to ensure the battery cells do not dry out and cause performance, degradation, and/or safety issues. Each battery cell may benefit from independent sensors to indicate when it is running low on electrolyte fluid and needs to be repaired, maintained, or refilled. These battery cell electrolyte fluid level sensors may benefit from being cost effective and resilient to the caustic electrolyte.

In various embodiments, each battery cell, for example each battery cell enclosure (e.g., enclosure 400), may be equipped with an isolated continuity sensor that is part of a loop connection to reduce pin and signal count. The electrolyte fluid sensor circuitry on each cell may receive an enable signal to generate an isolated current to test continuity between two probes that are composed of material that is chemically resistant to the electrolyte fluid, such as nickel. If there is electrical continuity then the sensor circuit passes the enable signal to the next cell, creating a loop wherein the Battery Management System (BMS) is sending the enable signal to the first cell and reading that enable signal on the last cell. If any cell is low on electrolyte fluid, the loop may be broken and the BMS may diagnose which cell it is and send a fault signal to trigger diagnostics or maintenance (e.g., request electrolyte filling). This solution provides isolated level sensing on each cell while saving on pin count and cable complexity.

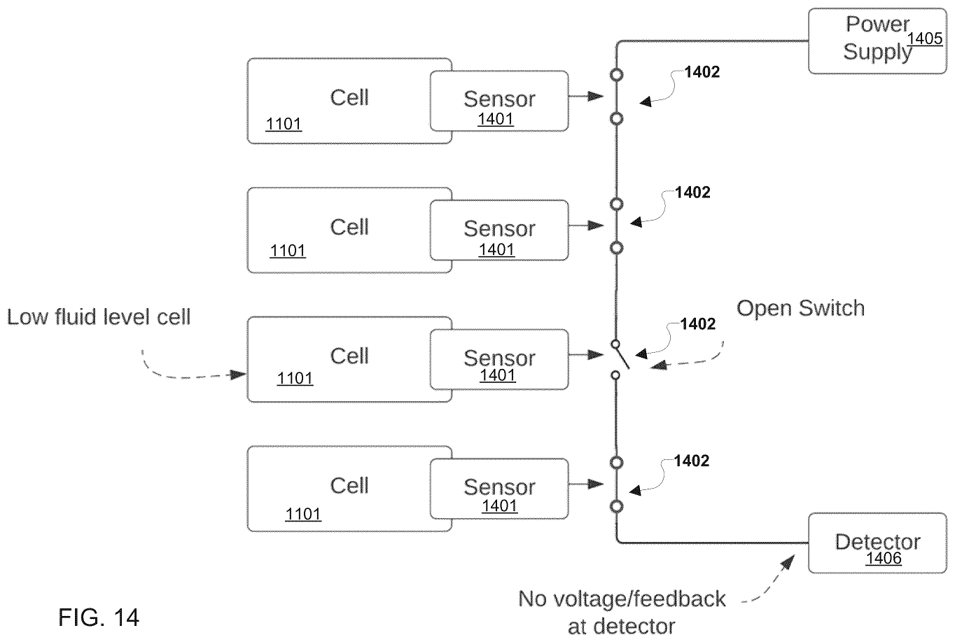

FIG. 14 is a block diagram illustrating an example of an interlocking loop electrolyte low fluid level detection circuit in accordance with various embodiments. With reference to FIGS. 1-14, the cells 1101 may each be associated with their own respective electrolyte level sensing circuit 1401 that may control a switch 1402. The switches 1402 may be wired in series between a power supply 1405 and a detector 1406. The power supply 1405 may output a voltage and when all the switches 1402 are closed, the voltage may be detected by the detector 1406. The sensing circuits 1401 may be configured to open their respective switch 1402 when the electrolyte level for the cell 1101 falls below a threshold level. For example, the sensor 1401 may sense a loss of a path of electrical continuity between contact pairs within the cell 1101 located at a minimum electrolyte level for the cell 1101 when the electrolyte level falls below the minimum electrolyte level threshold for the cell 1101 (i.e., the electrolyte no longer provided an electrical path between the contacts) and in response to that loss of a path of electrical continuity may open the switch 1402. Other embodiments of the electrolyte level sensor 1401 may use dissimilar metal probes to detect the presence of fluid due to a generated potential difference between the two materials. By making use of the electrical-chemical behavior of the cell 100, the dissimilar metal probes of the sensor 1401 may enable the sensor 1401 to act as a fluid level sensor while also being a reference electrode for cell state and health diagnostics and monitoring. Since the interlock loop goes through each cell 1101, if there is one cell with low electrolyte fluid level it breaks the loop. Breaking the loop results in no voltage at the detector 1406, which may be part of the BMS. Additionally, the BMS may read the voltage of the fluid level probe to determine cell 1101 state of charge and diagnose electrical-chemical issues. For example, in this manner, the BMS may use the voltage as measured by the probes as a proxy for cell 1101 state and health diagnostics. The voltage measurement at the detector 1406 being at, above, or below a selected voltage value or a loss of voltage at the detector 1406 may trigger the BMS to send a request to the electrolyte management system that may then be triggered to refill the cell electrolyte fluid. Alternatively, the BMS may trigger a fault signal which may prompt a technician to attend to the cells 1101 for diagnostics, repair, or maintenance related to the electrolyte levels of the cells 1101. The low electrolyte level also triggers the activation on an LED which indicates to technicians which cell needs maintenance. This LED indicator is on each low level sensor and is only activated when there is no continuity between the electrolyte probes.

Similarly, the sensing circuits 1401 may be configured to open their respective switch 1402 when the electrolyte conductivity for the cell 1101 falls below a certain threshold level. For example, the sensor 1401 may sense a change in the impedance (rather than strictly the continuity) between the contact pairs within the cell 1101 located at the minimum electrolyte level for the cell 1101 and in response may open the switch 1402. The impedance that triggers the switch 1402 to open may be tuned to a specific range of conductivity using components within the circuit or software controls. A reduction in electrolyte conductivity may be correlated with a performance or safety issue, which may necessitate further diagnostics, repair, or maintenance of the cell 1101. Specifically tuning the sensor 1401 trigger impedance may also avoid false positive signals due to conditions within the cells 1101 such as electrolyte misting or aging electrolyte.

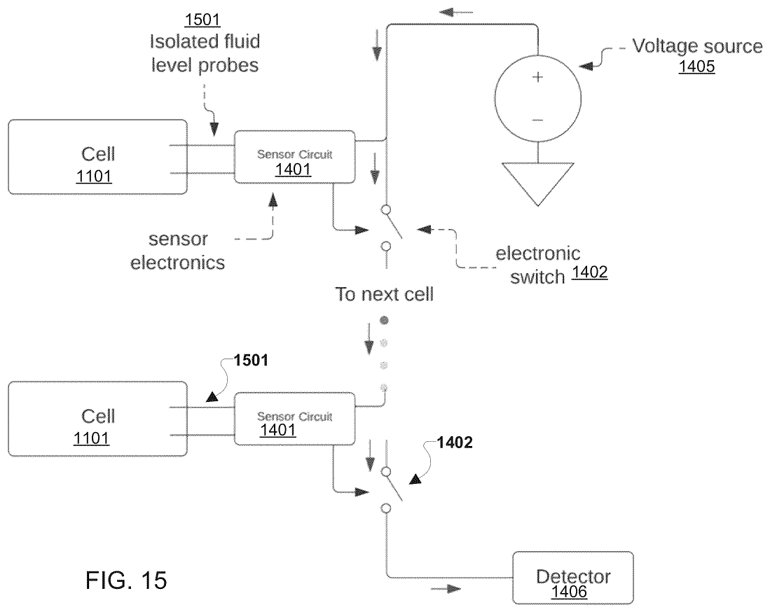

FIG. 15 illustrates cell electrolyte fluid level sensor configurations utilizing isolated electrolyte fluid level probes 1501 in accordance with various embodiments. With reference to FIGS. 1-15, the electrolyte fluid level probes 1501 may extend from the sensing circuits 1401 into the electrolyte of the cells 1101. When the electrolyte level is sufficient in the cell 1101, electrolyte may be present between the probes 1501. To determine the electrolyte fluid level in a cell 1101, an isolated sensor 1401 on each cell 1101 feeds current or voltage across two probes 1501 to detect if there is electrolyte fluid between those probes 1501. The sensor circuit 1401 is powered from an external source 1405 and if it detects there is electrolyte fluid between the probes 1501 it will route the incoming power out to the next cell 1101. The external power goes from cell 1101 to cell 1101 and eventually is fed into an external detector 1406. If the power source 1405 voltage makes it to the detector 1406 then it means all cells' 1101 electrolyte fluid levels are acceptable. When a cell is bypassed then the electrolyte sensor is also bypassed and the external signal is routed out to the next cell regardless of the state of the electrolyte level. The BMS may use the cell bypassing function to cycle through the fluid sensor on each cell to determine which cell(s) is/are low on electrolyte fluid. The BMS can log the low level fault and request cell filling from the electrolyte management system. Otherwise, if there is no power at the detector 1405 then the system knows that at least one cell 1101 needs to be filled or maintained. This solution creates an interlocking loop for all cells 1101. This loop reduces the wiring needed when compared to having independent cables routed to each cell 1101.

Similarly the BMS may determine the electrolyte fluid level in a cell 1101, via the voltage between the probes 1501 and a cell electrode, such as the anode, charge cathode, discharge cathode, etc. In such a manner, the sensor circuit 1401 may operate as a voltage sensor circuit. When there is fluid between the level sense probes 1501 and the internal electrode, such as the anode, a voltage may be generated between the probe 1501 and the electrode. A specific voltage range between the level sensor probes 1501 and the internal cell electrode indicates sufficient electrolyte fluid within a cell 1101. As one example, an appropriate voltage not being present between the probes 1501 (or between a probe and internal cell electrode) may indicate insufficient electrolyte fluid within a cell 1101. The BMS may also use that voltage reading for cell condition or state diagnostics. In this way, the fluid level sense probes 1501 may also be used to probe multiple fluid levels within a cell 1101. With two (or more) level sense probes 1501 at different levels, the voltage between each one and a cell electrode (e.g., anode, etc.) may provide a unique signal to indicate whether fluid is present at the level of the particular level sense probe. This approach reduces the number of fluid level sense probes 1501 for cost reduction; or it enables the use of existing fluid level sense probes 1501 to achieve more granular fluid level detection.

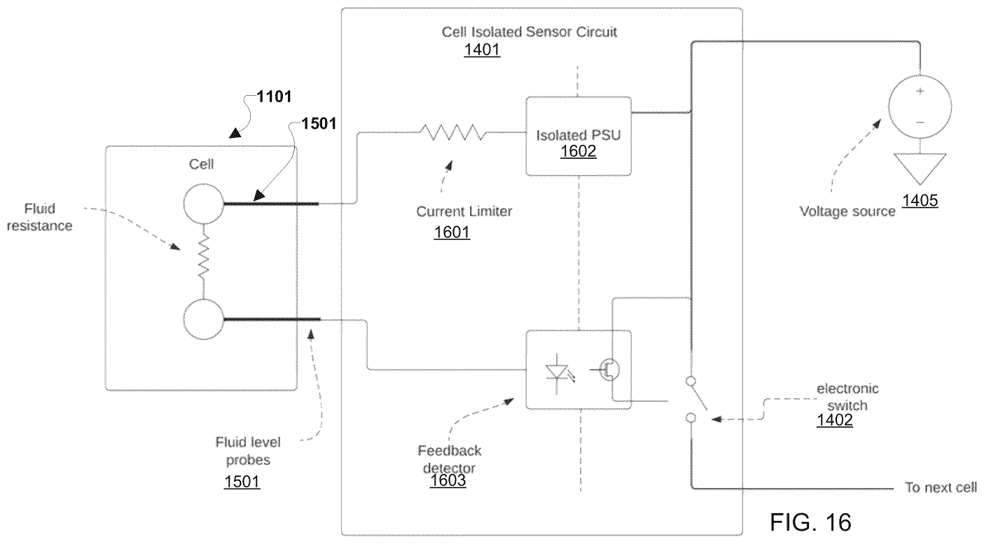

FIG. 16 illustrates an isolated electrolyte fluid sensor design in accordance with various embodiments. With reference to FIGS. 1-16, the sensing circuit 1401 on each cell 1101 may include an isolated power supply (PSU) 1602 to generate a current across the two probes 1501 extending into the cell 1101. A current limiting resistor 1601 may minimize the current through the fluid electrolyte of the cell 1101, thereby minimizing the power consumed by the circuit and the energy available at the terminals. The current through the cell 1101 electrolyte fluid is then sent to an opto-isolator detector 1603 that enables the solid-state electronic switch 1402. A comparator may drive the opto-isolator detector 1603 to control the switch 1402 into an open and closed state based on the appropriate current being detected or not between the probes 1501. The current from the external voltage source 1405 is sent through the switch 1402 and out to the next cell 1101.

The current limiting resistor 1601 is also a means to limit the energy available across the electrolyte fluid level sensor probes, preventing an arc or spark event within the cell headspace. This region of the cell may be subject to explosive gas buildup like hydrogen, so arc and spark events may present a significant safety hazard. Limiting the current across the probe also prevents electrolysis in the electrolyte, minimizing hydrogen generation and fluid loss. Other or additional components that limit the energy available at the fluid level sensor probes may also be utilized, such as transient voltage suppression (TVS) diodes.

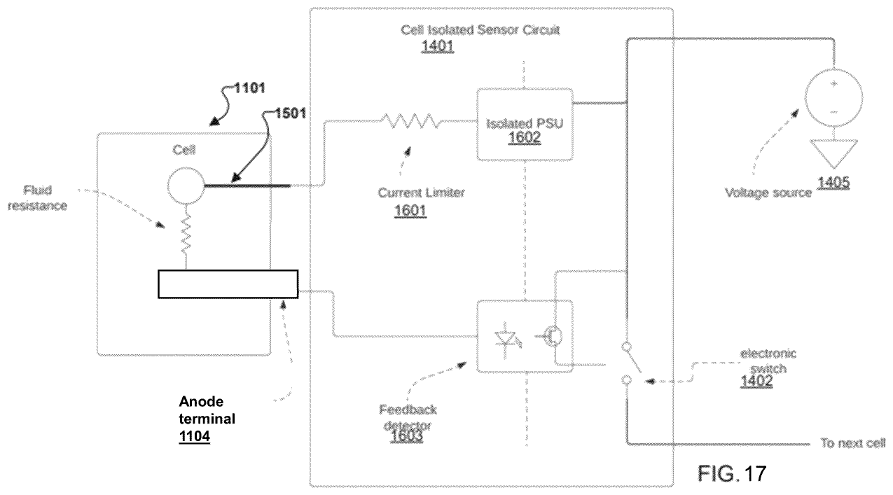

FIG. 17 illustrates an isolated electrolyte fluid sensor design in accordance with various embodiments. With reference to FIGS. 1-17, the design illustrated in FIG. 17 is similar to that illustrated in FIG. 16, except that rather than the sensing circuit 1401, such as a voltage sensor circuit or current sensor circuit, measuring the current or voltage between the probes 1501 alone, the voltage or current between a cell electrode, such as the anode connected to the anode terminal 1104, charge cathode, discharge cathode, etc., and one or more probes 1501 may be measured. For example, in the design illustrated in FIG. 17, the electrolyte low level detection may be provided by the sensing circuit 1401, such as a voltage sensor circuit, connected to probe(s) 1501 within the electrolyte of the cell 1101 and a cell electrode, such as the anode connected to anode terminal 1104, etc., that is configured to open the switch 1401 when the appropriate voltage is not present between the probe(s) 1501 and the cell electrode. The sensing circuit 1401, such as a voltage sensor circuit, may be configured such that a comparator may drive the opto-isolator detector 1603 to control the switch 1402 into an open and closed state based on the appropriate voltage being present or not between the probe(s) 1501 and the cell electrode, such as the anode.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides, one or more of the following: terminal switching between the charge cathode and the discharge cathode of the respective metal-air battery; bypass switching for the metal-air battery; and/or electrolyte low level detection for the metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides, one or more of the following: bypass switching for the metal-air battery; and/or electrolyte low level detection for the metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides, one or more of the following: terminal switching between the charge cathode and the discharge cathode of the respective metal-air battery; and/or electrolyte low level detection for the metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides, one or more of the following: terminal switching between the charge cathode and the discharge cathode of the respective metal-air battery; and/or bypass switching for the metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides terminal switching between the charge cathode and the discharge cathode of the respective metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides bypass switching for the metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides electrolyte low level detection for the metal-air battery.

Various embodiments may include a battery system comprising: a plurality of metal-air batteries, wherein each metal-air battery comprises: a charge cathode; a discharge cathode; a metal anode; and a liquid electrolyte; and cell electronics associated with each of the plurality of metal-air batteries, wherein each cell electronics provides, one or more of the following: terminal switching between the charge cathode and the discharge cathode of the respective metal-air battery; bypass switching for the metal-air battery; and/or electrolyte low level detection for the metal-air battery. In various embodiments, the terminal switching may be provided by in-line switches connected to a charge cathode terminal of the metal-air battery and a discharge cathode terminal of the metal-air battery. In various embodiments, the in-line switches may be semiconductor switches, electromechanical switches, or combinations of semiconductor switches and electromechanical switches. In various embodiments, the in-line switches comprise MOSFETs. In various embodiments, the in-line switch of the discharge cathode terminal comprises two MOSFETs arranged back-to-back. In various embodiments, the bypass switching may be provided by an in-line switch connected to a metal anode terminal of the metal-air battery. In various embodiments, the in-line switch may be a semiconductor switch, an electromechanical switch, or a combination of a semiconductor switch and an electromechanical switch. In various embodiments, the in-line switch comprises a MOSFET. In various embodiments, the electrolyte low level detection may be provided by a current sensor circuit connected to probes within the electrolyte of the metal-air cell that is configured to open an electronic switch when current is not present between the probes. In various embodiments, the current sensor circuit comprises an isolated power supply generating a current across the probes and an opto-isolator detector controlling the electronic switch open and closed state. In various embodiments, at least a portion of the current sensor circuits for a respective portion of the metal-air batteries may be connected in series via their respective electronic switches between a voltage source and a voltage detector, such that when a voltage from the voltage source is not detected by the voltage detector a low electrolyte condition for at least one of the metal-air batteries is indicated. In various embodiments, the electrolyte low level detection may be provided by a voltage sensor circuit connected to probes within the electrolyte of the metal-air cell that is configured to open an electronic switch when the appropriate voltage is not present between the probes. In various embodiments, the voltage sensor circuit comprises a voltage sensing circuit on the probes and a comparator to drive an opto-isolator controlling the electronic switch open and closed state. In various embodiments, at least a portion of the voltage sensor circuits for a respective portion of the metal-air batteries may be connected in series via their respective electronic switches between a voltage source and a voltage detector, such that when a voltage from the voltage source is not detected by the voltage detector a low electrolyte condition for at least one of the metal-air batteries is indicated. In various embodiments, the electrolyte low level detection may be provided by a voltage sensor circuit connected to one or more probes within the electrolyte of the metal-air cell and a cell electrode that is configured to open an electronic switch when the appropriate voltage is not present between the one or more probes and the cell electrode. In various embodiments, the voltage sensor circuit comprises a voltage sensing circuit on the probes and a comparator to drive an opto-isolator controlling the electronic switch open and closed state. In various embodiments, a voltage between the one or more probes and the cell electrode provides cell state diagnostics for the metal-air battery In various embodiments, at least a portion of the voltage sensor circuits connected to probes for a respective portion of the metal-air batteries are connected in series via their respective electronic switches between a voltage source and a voltage detector, such that when a voltage from the voltage source is not detected by the voltage detector a low electrolyte condition for at least one of the metal-air batteries is indicated. In various embodiments, the electrolyte low level detection may be provided by a sensor circuit connected to probes within the electrolyte of the metal-air cell that is configured to measure impedance between the probes and to open an electronic switch when an impedance trigger threshold is reached. In various embodiments, at least a portion of the sensor circuits connected to probes for a respective portion of the metal-air batteries are connected in series via their respective electronic switches between a voltage source and a voltage detector, such that when a voltage from the voltage source is not detected by the voltage detector a low electrolyte condition for at least one of the metal-air batteries is indicated. In various embodiments, the metal-air batteries comprise iron-air type battery cells, zinc-air type battery cells, and/or lithium-air battery cells.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A battery system comprising:
a plurality of metal-air batteries, wherein each metal-air battery comprises:
a charge cathode;
a discharge cathode;
a metal anode; and
a liquid electrolyte; and
cell electronics associated with each of the plurality of metal-air batteries, wherein each cell electronics provides one or more of the following:
terminal switching between the charge cathode and the discharge cathode of the respective metal-air battery;
bypass switching for the metal-air battery; and/or
electrolyte low level detection for the metal-air battery.

2. The battery system of claim 1, wherein the terminal switching is provided by in-line switches connected to a charge cathode terminal of the metal-air battery and a discharge cathode terminal of the metal-air battery.

3. The battery system of claim 2, wherein the in-line switches are semiconductor switches or electromechanical switches.

4. The battery system of claim 3, wherein the in-line switches comprise MOSFETs.

5. The battery system of claim 4, wherein the in-line switch of the discharge cathode terminal comprises two MOSFETs arranged back-to-back.

6. The battery system of claim 1, wherein the bypass switching is provided by an in-line switch connected to a metal anode terminal of the metal-air battery.

7. The battery system of claim 6, wherein the in-line switch is a semiconductor switch or an electromechanical switch.

8. The battery system of claim 7, wherein the in-line switch comprises a MOSFET.

9. The battery system of claim 1, wherein the electrolyte low level detection is provided by a current sensor circuit connected to probes within the electrolyte of the metal-air cell that is configured to open an electronic switch when current is not present between the probes.

10. The battery system of claim 9, wherein the current sensor circuit comprises an isolated power supply generating a current across the probes and an opto-isolator detector controlling the electronic switch open and closed state.

11. The battery system of claim 9, wherein at least a portion of the current sensor circuits for a respective portion of the metal-air batteries are connected in series via their respective electronic switches between a voltage source and a voltage detector, such that when a voltage from the voltage source is not detected by the voltage detector a low electrolyte condition for at least one of the metal-air batteries is indicated.

12. The battery system of claim 1, wherein the electrolyte low level detection is provided by a voltage sensor circuit connected to probes within the electrolyte of the metal-air cell that is configured to open an electronic switch when the appropriate voltage is not present between the probes.

13. The battery system of claim 12, wherein the voltage sensor circuit comprises a voltage sensing circuit on the probes and a comparator to drive an opto-isolator controlling the electronic switch open and closed state.

14. The battery system of claim 12, wherein at least a portion of the voltage sensor circuits for a respective portion of the metal-air batteries are connected in series via their respective electronic switches between a voltage source and a voltage detector, such that when a voltage from the voltage source is not detected by the voltage detector a low electrolyte condition for at least one of the metal-air batteries is indicated.

15. The battery system of any of claim 1, wherein the electrolyte low level detection is provided by a voltage sensor circuit connected to one or more probes within the electrolyte of the metal-air cell and a cell electrode that is configured to open an electronic switch when the appropriate voltage is not present between the one or more probes and the cell electrode.

16. The battery system of claim 15, wherein the voltage sensor circuit comprises a voltage sensing circuit on the one or more probes and a comparator to drive an opto-isolator controlling the electronic switch open and closed state.

17. The battery system of claim 16, wherein a voltage between the one or more probes and the cell electrode provides cell state diagnostics for the metal-air battery.

18. The battery system of claim 15, wherein at least a portion of the voltage sensor circuits connected to probes for a respective portion of the metal-air batteries are connected in series via their respective electronic switches between a voltage source and a voltage detector, such that when a voltage from the voltage source is not detected by the voltage detector a low electrolyte condition for at least one of the metal-air batteries is indicated.

19. The battery system of claim 1, wherein the electrolyte low level detection is provided by a sensor circuit connected to probes within the electrolyte of the metal-air cell that is configured to measure impedance between the probes and to open an electronic switch when an impedance trigger threshold is reached.

20. The battery system of claim 15, wherein at least a portion of the sensor circuits connected to probes for a respective portion of the metal-air batteries are connected in series via their respective electronic switches between a voltage source and a voltage detector, such that when a voltage from the voltage source is not detected by the voltage detector a low electrolyte condition for at least one of the metal-air batteries is indicated.

21. A battery system comprising:
a plurality of metal-air batteries, wherein each metal-air battery comprises:
a charge cathode;
a discharge cathode;
a metal anode; and
a liquid electrolyte; and
cell electronics associated with each of the plurality of metal-air batteries, wherein each cell electronics provides:
terminal switching between the charge cathode and the discharge cathode of the respective metal-air battery; and
bypass switching for the metal-air battery.

22. The battery system of claim 21, wherein:
the terminal switching is provided by in-line switches connected to a charge cathode terminal of the metal-air battery and a discharge cathode terminal of the metal-air battery; and
the bypass switching is provided by an in-line switch connected to a metal anode terminal of the metal-air battery.

23. A battery system comprising:
a plurality of metal-air batteries, wherein each metal-air battery comprises:
a charge cathode;
a discharge cathode;
a metal anode; and
a liquid electrolyte; and
cell electronics associated with each of the plurality of metal-air batteries, wherein each cell electronics provides:
terminal switching between the charge cathode and the discharge cathode of the respective metal-air battery;
bypass switching for the metal-air battery; and
electrolyte low level detection for the metal-air battery.

24. The battery system of claim 19, wherein the metal-air batteries comprise iron-air type battery cells, zinc-air type battery cells, and/or lithium-air battery cells.
